(19) United States
(12) Patent Application Publication
(10) Pub. No.: US 2017/0169595 A1
(43) Pub. Date: Jun. 15, 2017

(54) INFORMATION SUPERIMPOSED IMAGE DISPLAY DEVICE, NON-TRANSITORY COMPUTER-READABLE MEDIUM WHICH RECORDS INFORMATION SUPERIMPOSED IMAGE DISPLAY PROGRAM, AND INFORMATION SUPERIMPOSED IMAGE DISPLAY METHOD

(71) Applicant: MITSUBISHI ELECTRIC CORPORATION, Tokyo (JP)

(72) Inventor: Jumpei HATO, Tokyo (JP)

(73) Assignee: MITSUBISHI ELECTRIC CORPORATION, Tokyo (JP)

(21) Appl. No.: 15/311,812

(22) PCT Filed: Jun. 13, 2014
(86) PCT No.: PCT/JP2014/065684

§ 371 Date: Nov. 16, 2016

(51) Int. Cl. G06T 11/60; G06F 3/0481

(52) U.S. Cl. CPC G06T 11/60; G06F 3/0481; G06T 2200/16; G06T 2200/21

(57) ABSTRACT

An unusable area selection unit (130) selects, from a photographic image (191) showing an information processing display device, a display area of the information processing display device, as an unusable area. An AR image generation unit (140) generates an AR image (194) by superimposing superimposing information (192) over a photographic image to avoid an unusable area. An AR image display unit (150) displays the AR image (194) in the display area of an AR display device. AR is an abbreviation of augmented reality.

### TECHNICAL FIELD

The present invention relates to a technique for displaying information by superimposing the information over a photographic image.

### BACKGROUND ART

An AR technology has been prevailing which superimposes and displays CG generated by a computer over the real word or an image that reflects the real world. CG is an abbreviation of computer graphics and AR is an abbreviation of augmented reality.

For example, a method is available which projects CG from a projector over a building existing in a direction in which the user faces. Also, a method is available which superimposes and displays CG when an image photographed by a camera provided to an information terminal such as a smart phone, a tablet-type terminal, or a wearable terminal is to be displayed on the screen of the information terminal.

These techniques can be used in usages such as a tourist assistance system which displays information explaining a neighboring building to a tourist and a navigation system which displays a route to a destination by CG.

When CG is superimposed and displayed over the real world, part of the real world existing in the portion where the CG is superimposed and displayed cannot be seen or is difficult to see. This situation will not pose a problem if the real world corresponding to the CG superimposed portion need not be seen, but will become an issue in terms of usability if the real world is to be seen.

A display device which transmits information useful to the user exists in the real word, other than an information processing terminal which superimposes and displays CG by the AR technology. Therefore, if CG is superimposed and displayed over a portion where a display device is displayed, information transmitted by the display device will be blocked, and the profit of the user will be impaired.

Patent Literature 1 discloses a technique which, by specifying a CG excluding area where CG will not be superimposed and displayed, prevents CG from being superimposed and displayed over the CG excluding area.

Note that the user must clearly specify the CG excluding area by using a CG excluding frame or an electronic pen, or with his or her own hands.

This requires a labor for adjusting the position and size of the CG excluding area. Also, as the CG will not be superimposed and displayed on the CG excluding area, the CG to be superimposed and displayed is likely to be missed partly. If the CG excluding area is larger than needed, it is likely that the CG is not displayed at all. As a result, information will not be transmitted effectively.

When CG is superimposed and displayed on the display device, it is difficult for the user to recognize information displayed on the display device.

### CITATION LIST

### Patent Literature

Patent Literature 1: JP 2004-178554

### Non-Patent Literature

Non-Patent Literature 1: Yasushi KANAZAWA, “Measurement of Obstacles on Road by Mobile Monocular Camera”, [online], Jul. 10, 2012, [retrieved on Apr. 7, 2014], Internet (URL:http://jstshingi.jp/abst/p/12/1216/toyohashi04.pdf)

### SUMMARY OF INVENTION

### Technical Problem

The present invention has as its objective to enable superimposing and displaying information over a photographic image without concealing the display area of a display device shown on the photographic image.

### Solution to Problem

An information superimposed image display device according to the present invention includes:

an information superimposed image display unit to display an information superimposed image generated by superimposing superimposing information over a photographic image showing an information processing display device having an information processing display area as a display area, on a main body display area of a main body display device having the main body display area as a display area,

wherein the information superimposed image is an image in which the information is superimposed over an image area being selected from the photographic image to avoid a portion showing the information processing display area of the information processing display device.

### Advantageous Effects of Invention

According to the present invention, information can be superimposed and displayed over a photographic image without concealing the display area of a display device shown on the photographic image.

### BRIEF DESCRIPTION OF DRAWINGS

FIG. 1 is a functional configuration diagram of an AR device 100 according to Embodiment 1.

FIG. 2 is a flowchart illustrating an AR process of the AR device 100 according to Embodiment 1.

FIG. 3 illustrates an example of a photographic image 191 according to Embodiment 1.

FIG. 4 is a diagram illustrating an example of an unusable area 390 included in the photographic image 191 according to Embodiment 1.

FIG. 5 is a diagram illustrating an example of an AR image 194 according to Embodiment 1.

FIG. 6 is a diagram illustrating an example of the display mode of the AR image 194 according to Embodiment 1.

FIG. 7 is a hardware configuration diagram of the AR device 100 according to Embodiment 1.

FIG. 8 is a diagram illustrating an example of an AR image 194 according to the prior art.

FIG. 9 is a functional configuration diagram of a superimposing information acquisition unit 120 according to Embodiment 2.

FIG. 10 is a functional configuration diagram of a superimposing information acquisition unit 120 according to Embodiment 3.

FIG. 11 is a diagram illustrating an example of an AR image 194 according to Embodiment 3.

FIG. 12 is a functional configuration diagram of an unusable area selection unit 130 according to Embodiment 4.

FIG. 13 is a functional configuration diagram of an unusable area selection unit 130 according to Embodiment 5.

FIG. 14 is a diagram illustrating an example of a plurality of icons 330 displayed on a display area 201 according to Embodiment 5.

FIG. 15 is a diagram illustrating an example of a window 340 according to Embodiment 5.

FIG. 16 is a diagram illustrating part of an example of a photographic image 191 according to Embodiment 5.

FIG. 17 is a diagram illustrating part of an example of the photographic image 191 according to Embodiment 5.

FIG. 18 is a diagram illustrating an example of an unusable area 390 according to Embodiment 5.

FIG. 19 is a diagram illustrating an example of the unusable area 390 according to Embodiment 5.

FIG. 20 is a flowchart illustrating an unusable area determination process of an unusable area determination unit 133 according to Embodiment 5.

FIG. 21 is a functional configuration diagram of an unusable area selection unit 130 according to Embodiment 6.

FIG. 22 is a diagram illustrating an example of a bezel portion 393 according to Embodiment 6.

FIG. 23 is a diagram illustrating an example of an unusable area 390 according to Embodiment 6.

FIG. 24 is a diagram illustrating examples of the bezel portion 393 according to Embodiment 6.

FIG. 25 is a diagram illustrating examples of the unusable area 390 according to Embodiment 6.

FIG. 26 is a diagram illustrating examples of the bezel portion 393 according to Embodiment 6.

FIG. 27 is a diagram illustrating an example of the unusable area 390 according to Embodiment 6.

FIG. 28 is a functional configuration diagram of an AR image generation unit 140 according to Embodiment 7.

FIG. 29 is a flowchart illustrating an AR image generation process of the AR image generation unit 140 according to Embodiment 7.

FIG. 30 is a diagram illustrating an example of an information part illustration 322 according to Embodiment 7.

FIG. 31 is a diagram illustrating modifications of the information part illustration 322 according to Embodiment 7.

FIG. 32 is a diagram illustrating an example of an information illustration 320 according to Embodiment 7.

FIG. 33 is a diagram illustrating an example of an information image 329 according to Embodiment 7.

FIG. 34 is a functional configuration diagram of an AR device 100 according to Embodiment 8.

FIG. 35 is a flowchart illustrating an AR process of an AR device 100 according to Embodiment 8.

FIG. 36 is a diagram illustrating a positional relationship of an excluding area 398 according to Embodiment 8.

### DESCRIPTION OF EMBODIMENTS

### Embodiment 1

An embodiment will be described in which information is superimposed and displayed over a photographic image without concealing the display area of a display device shown on the photographic image.

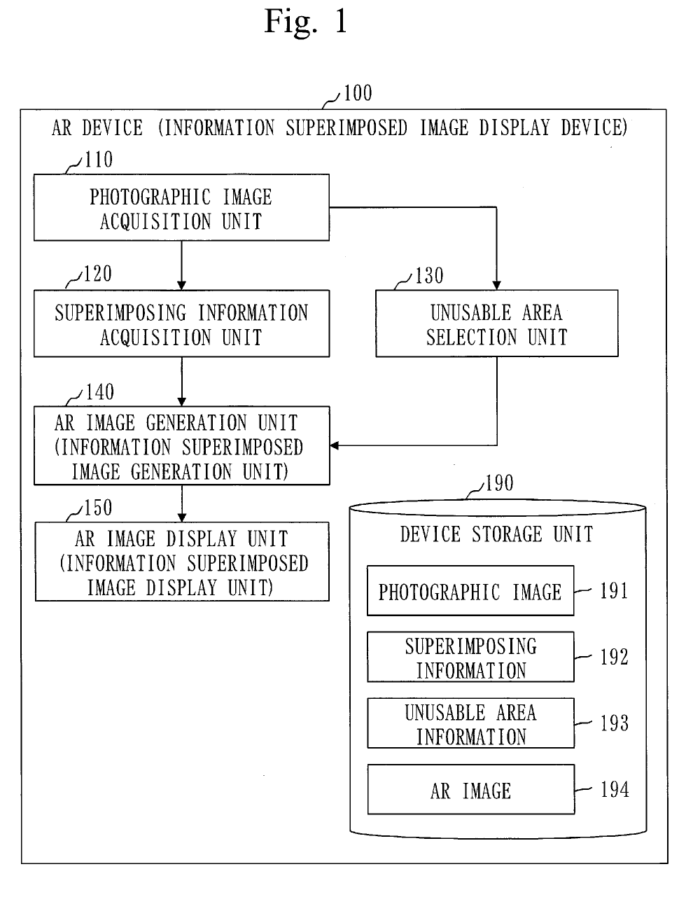

FIG. 1 is a functional configuration diagram of an AR device 100 according to Embodiment 1. AR is an abbreviation of Augmented Reality.

The functional configuration of the AR device 100 according to Embodiment 1 will be described with referring to FIG. 1. The functional configuration of the AR device 100 may be different from that illustrated in FIG. 1.

The AR device 100 (an example of an information superimposed image display device) is a device that displays an AR image 194 over the display area (an example of a main body display area) of a display device provided to the AR device 100. The AR image 194 is an information superimposed image on which image is superimposed.

The AR device 100 is provided with a camera and the display device (an example of a main body display device) (not illustrated). The camera and display device may be connected to the AR device 100 via cables or the like. The display device provided to the AR device 100 will be referred to as display device or AR display device hereinafter.

A tablet-type computer, a smart phone, and a desktop computer are examples of the AR device 100.

The AR device 100 is provided with a photographic image acquisition unit 110, a superimposing information acquisition unit 120, an unusable area selection unit 130, an AR image generation unit 140 (an example of an information superimposed image generation unit), an AR image display unit 150 (an example of an information superimposed image display unit), and a device storage unit 190.

The photographic image acquisition unit 110 acquires a photographic image 191 generated by the camera.

The photographic image 191 shows a photographic area where the display device used by the information processing device exists. The display device used by the information processing device will be called display device or information processing display device hereinafter. The image displayed in the display area of the information processing display device will be called information processing image.

The superimposing information acquisition unit 120 acquires superimposing information 192 to be superimposed over the photographic image 191.

The unusable area selection unit 130 selects from the photographic image 191 an image area showing the display area of the information processing display device and generates unusable area information 193 indicating the selected image area, as an unusable area.

The AR image generation unit 140 generates an AR image 194 based on the superimposing information 192 and unusable area information 193.

The AR image 194 is the photographic image 191 with the superimposing information 192 being superimposed on an image area other than the unusable area.

The AR image display unit 150 displays the AR image 194 onto an AR display device.

The device storage unit 190 stores data which is used, generated, or received/outputted by the AR device 100.

For example, the device storage unit 190 stores the photographic image 191, superimposing information 192, unusable area information 193, AR image 194, and so on.

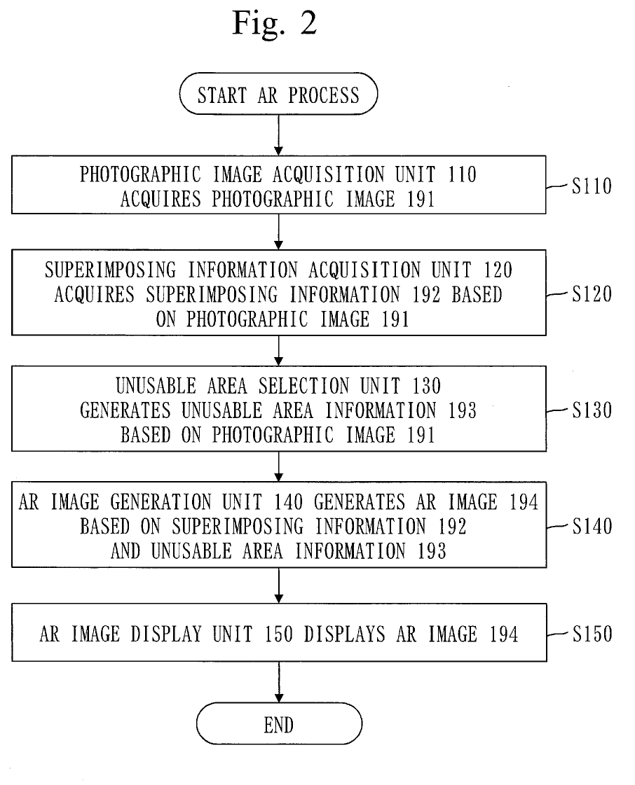

FIG. 2 is a flowchart illustrating an AR process of the AR device 100 according to Embodiment 1.

The AR process of the AR device 100 according to Embodiment 1 will be described with referring to FIG. 2. The AR process may be a process different from that illustrated in FIG. 2.

The AR process illustrated in FIG. 2 is executed each time the camera of the AR device 100 generates a photographic image 191.

In S110, the photographic image acquisition unit 110 acquires the photographic image 191 generated by the camera of the AR device 100.

After S110, the process proceeds to S120.

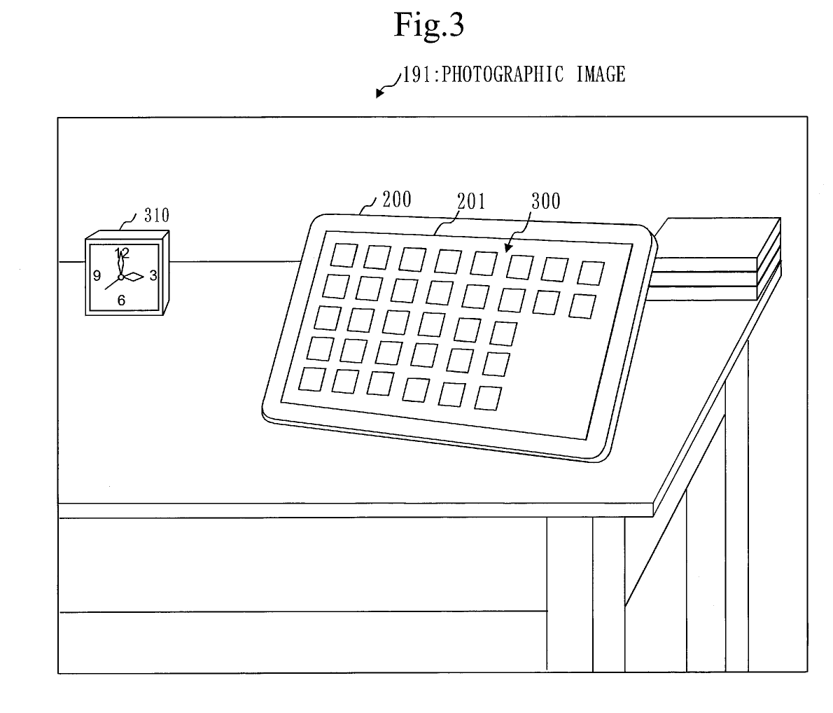

FIG. 3 illustrates an example of a photographic image 191 according to Embodiment 1.

For example, the photographic image acquisition unit 110 acquires the photographic image 191 as illustrated in FIG. 3.

The photographic image 191 shows a photographic area including a tablet-type information processing device 200 and a clock 310.

The tablet-type information processing device 200 is provided with a display device. The display device of the information processing device 200 is provided with a display area 201 that displays an information processing image 300.

Back to FIG. 2, the explanation resumes with S120.

In S120, the superimposing information acquisition unit 120 acquires the superimposing information 192 to be superimposed over the photographic image 191.

For example, the superimposing information acquisition unit 120 detects the clock 310 from the photographic image 191 (see FIG. 3) and acquires superimposing information 192 concerning the clock 310.

A superimposing information acquisition process (S120) will be described later in detail in another embodiment.

After S120, the process proceeds to S130. S120 may be executed after S130. Alternatively, S120 may be executed in parallel with S130.

In S130, the unusable area selection unit 130 selects, as an unusable area 390, an image area that shows the display area 201 of the information processing device 200, from the photographic image 191. The unusable area 390 is a square image area where the superimposing information 192 will not be superimposed. The shape of the unusable area 390 need not be square.

The unusable area selection unit 130 then generates the unusable area information 193 which shows an unusable area.

An unusable area selection process (S130) will be described later in detail in another embodiment.

After S130, the process proceeds to S140.

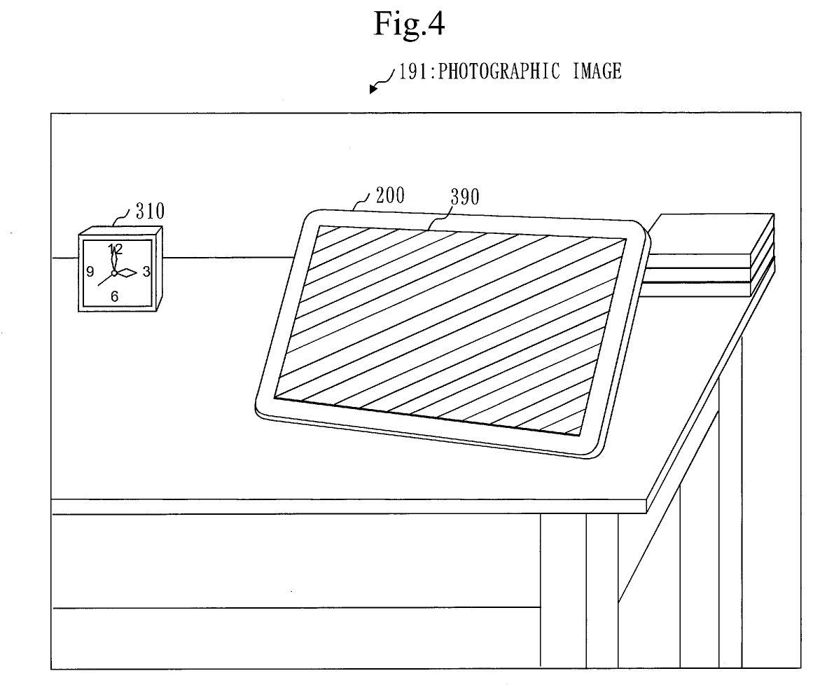

FIG. 4 is a diagram illustrating an example of the unusable area 390 included in the photographic image 191 according to Embodiment 1. Referring to FIG. 4, a diagonally shaded portion represents the unusable area 390.

The unusable area selection unit 130 selects, as the unusable area 390, the display area of the information processing device 200 entirely or partly, and generates the unusable area information 193 that shows the selected unusable area 390.

Back to FIG. 2, the explanation resumes with S140.

In S140, the AR image generation unit 140 generates the AR image 194 based on the superimposing information 192 and the unusable area information 193.

The AR image 194 is the photographic image 191 with the superimposing information 192 being superimposed to avoid the unusable area.

An AR image generation process (S140) will be described later in detail in another embodiment.

After S140, the process proceeds to S150.

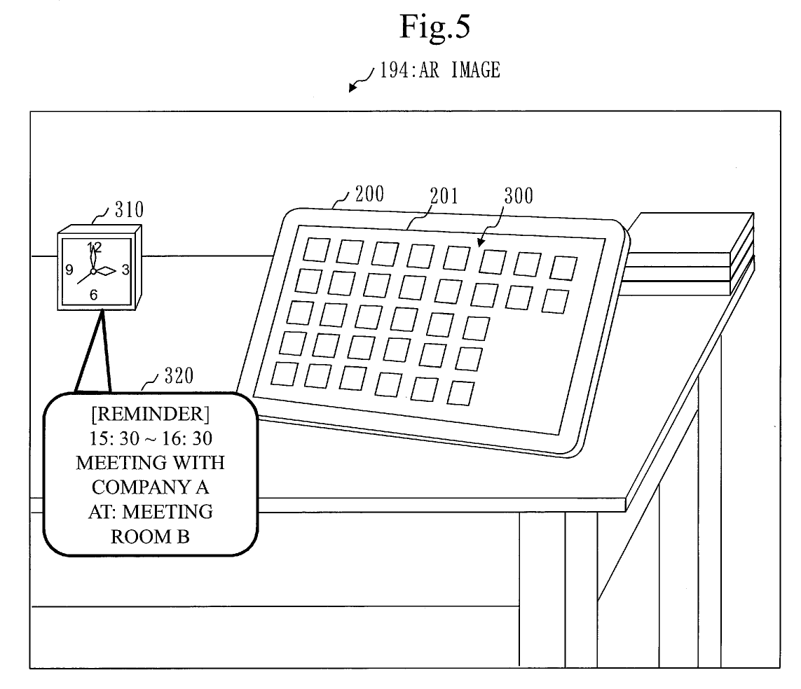

FIG. 5 is a diagram illustrating an example of the AR image 194 according to Embodiment 1.

For example, the AR image generation unit 140 generates the AR image 194 as illustrated in FIG. 5.

The AR image 194 includes a speech-balloon-like information illustration 320. The information illustration 320 indicates, as the superimposing information 192, schedule information of a time close to the current time indicated by the clock 310. The information illustration 320 is CG (Computer Graphics).

Back to FIG. 2, the explanation resumes with S150.

In S150, the AR image display unit 150 displays the AR image 194 on the display device of the AR device 100.

After S150, the AR process for one photographic image 191 ends.

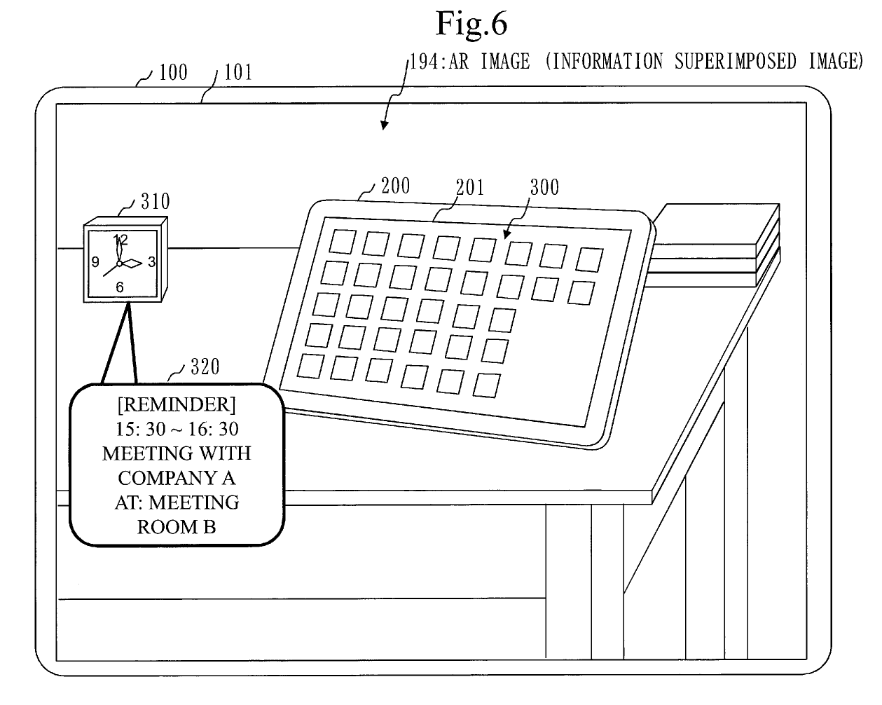

FIG. 6 is a diagram illustrating an example of the display mode of the AR image 194 according to Embodiment 1.

For example, the AR image display unit 150 displays the AR image 194 over the display area 101 of the display device provided to the tablet-type AR device 100 (see FIG. 6).

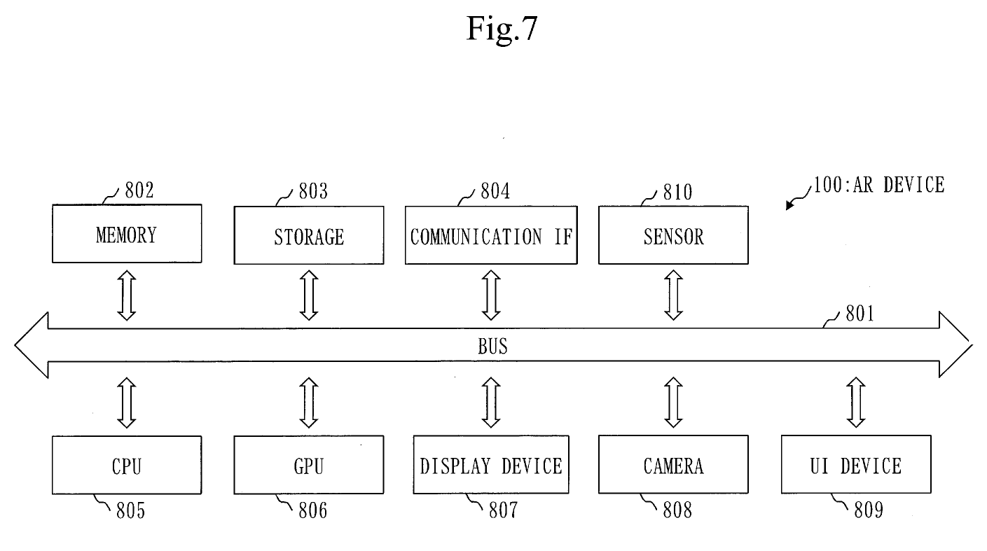

FIG. 7 is a hardware configuration diagram of the AR device 100 according to Embodiment 1.

The hardware configuration of the AR device 100 according to Embodiment 1 will be described with referring to FIG. 7. The hardware configuration of the AR device 100 may be different from the configuration illustrated in FIG. 7.

The AR device 100 is a computer.

The AR device 100 is provided with a bus 801, a memory 802, a storage 803, a communication interface 804, a CPU 805, and a GPU 806.

The AR device 100 is further provided with a display device 807, a camera 808, a user interface device 809, and a sensor 810.

The bus 801 is a data transmission path which the hardware of the AR device 100 uses to exchange data.

The memory 802 is a volatile storage device into which data is written or from which data is read out by the hardware of the AR device 100. The memory 802 may be a non-volatile storage device. The memory 802 is also called main storage device.

The storage 803 is a non-volatile storage device into which data is written or from which data is read out by the hardware of the AR device 100. The storage 803 may also be called auxiliary storage device.

The communication interface 804 is a communication device which the AR device 100 uses to exchange data with an external computer.

The CPU 805 is a computation device that executes a process (for example, the AR process) carried out by the AR device 100. CPU is an abbreviation of Central Processing Unit.

The GPU 806 is a computation device that executes a process related to computer graphics (CG). The process related to CG may be executed by the CPU 805. The AR image 194 is an example of data generated by the CG technology. GPU is an abbreviation of Graphics Processing Unit.

The display device 807 is a device that converts CG data into an optical output. Namely, the display device 807 is a display device that displays CG.

The camera 808 is a device that converts an optical input into data. Namely, the camera 808 is a photographing device that generates an image by photographing. Each image is called a still image. A plurality of still images that are consecutive in the time-series manner are called a motion image or video image

The user interface device 809 is an input device which the user utilizing the AR device 100 uses to operate the AR device 100. The keyboard and pointing device provided to a desktop-type computer are examples of the user interface device 809. A mouse and tracking ball are examples of the pointing device. A touch panel and microphone provided to a smart phone or tablet-type computer are examples of the user interface device 809.

The sensor 810 is a measuring device for detecting the AR device 100 or the surrounding circumstances. A GPS which measures the position, an acceleration sensor which measures the acceleration, a gyro sensor which measures the angular velocity, a magnetic sensor which measures the orientation, a proximity sensor which detects the presence of a nearby object, and an illuminance sensor which detects the illuminance are examples of the sensor 810.

Programs each for implementing the function described as “unit” are stored in the storage 803, loaded to the memory 802 from the storage 803, and executed by the CPU 805.

Information, data, files, signal values, or variable values representing the results of processes such as “determination”, “checking”, “extraction”, “detection”, “setting”, “registration”, “selection”, “generation”, “inputting”, and “outputting” are stored in the memory 802 or storage 803.

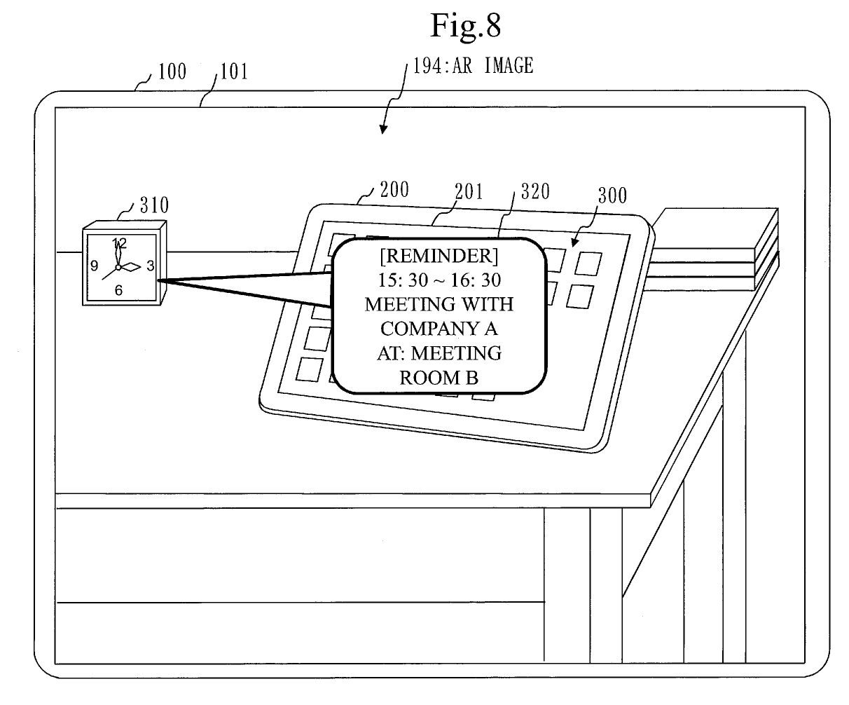

FIG. 8 is a diagram illustrating an example of the AR image 194 according to the prior art.

In the prior art, the information illustration 320 may be superimposed on the display area 201 of the information processing device 200 (see FIG. 8). In this case, the information processing image 300 displayed on the display area 201 of the information processing device 200 is hidden by the information illustration 320 and thus cannot be seen.

Therefore, when useful information is included in the information processing image 300, the user cannot obtain the useful information from the AR image 194. If the user wishes to see the information processing image 300, he or she must switch the gaze from the display device of the AR image 194 to the display device of the information processing device 200.

The AR device 100 in Embodiment 1 superimposes and displays the information illustration 320 to avoid the display area 201 (see FIG. 6).

Referring to FIG. 6, the information illustration 320 overlaps the bezel of the information processing device 200 but not overlap the display area 201. If the information illustration 320 should overlap the peripheral equipment of the information processing device 200, it will not overlap the display area 201.

Therefore, the user can obtain both of information described on the information illustration 320 and information described on the information processing image 300, from the AR image 194.

According to Embodiment 1, information can be superimposed and displayed over a photographic image without hiding the display area of the display device displayed on the photographic image.

### Embodiment 2

A superimposing information acquisition unit 120 of an AR device 100 will be described.

Matters that are not described in Embodiment 1 will mainly be described hereinafter. Matters whose description is omitted are equivalent to those of Embodiment 1.

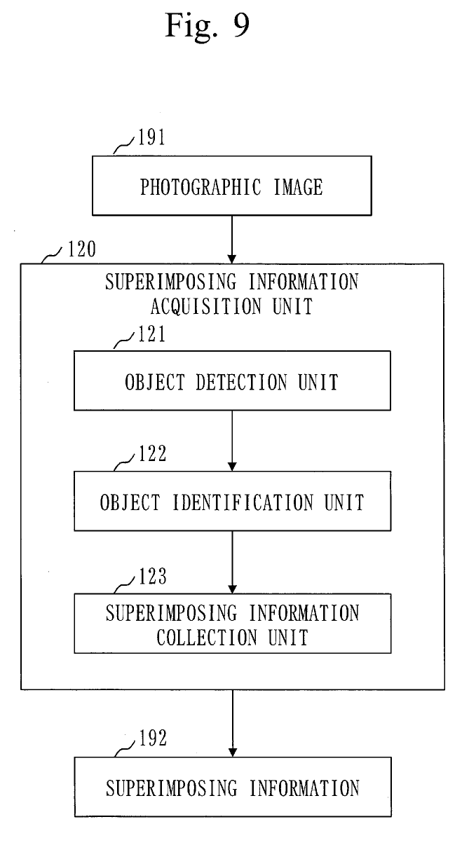

FIG. 9 is a functional configuration diagram of the superimposing information acquisition unit 120 according to Embodiment 2.

The functional configuration of the superimposing information acquisition unit 120 according to Embodiment 2 will be described with referring to FIG. 9. The functional configuration of the superimposing information acquisition unit 120 may be a functional configuration different from that in FIG. 9.

The superimposing information acquisition unit 120 is provided with an object detection unit 121, an object identification unit 122, and a superimposing information collection unit 123.

The object detection unit 121 detects an object shown on a photographic image 191 from the photographic image 191. In other words, the object detection unit 121 detects an object area where the object is shown, from the photographic image 191.

For example, the object detection unit 121 detects a clock 310 shown on the photographic image 191 (see FIG. 3) from the photographic image 191.

For example, the object detection unit 121 detects the object from the photographic image 191 by a marker method or markerless method.

The marker method is a method of detecting an object added with a marker, by detecting the marker added to the object (including the image of the object) from the photographic image 191. The marker is a special pattern such as barcode. The marker is created based on object information concerning the object. The object information includes type information indicating the type of the object, coordinate values representing the position of the object, size information indicating the size of the object, and so on.

The markerless method is a method of extracting a geometric or optical feature amount from the photographic image 191 and detecting an object based on the extracted feature amount. Amounts expressing the shape, color, and luminance of the object are examples of the feature amount expressing the feature of the object. Characters and symbols described on the object are examples of the feature amount expressing the feature of the object.

For example, the object detection unit 121 extracts an edge representing the shape of the object shown on the photographic image 191 and detects an object area surrounded by the extracted edge. Namely, the object detection unit 121 detects an object area whose boundary line is formed of the extracted edge.

The object identification unit 122 identifies the type of the object detected by the object detection unit 121. The object identification unit 122 also acquires type information indicating the type of the object detected by the object detection unit 121.

For example, the type information is described in JSON format. The JSON is an abbreviation of JavaScript Object Notation. Java and JavaScript are registered trademarks.

For example, the object identification unit 122 identifies the detected object as a clock 310 based on the shape, face, hour hand, minute hand, second hand, and so on of the object detected from the photographic image 191 (see FIG. 3).

For example, when the object is detected by the marker method, the object identification unit 122 reads the type information of the object from the marker.

For example, when the object is detected by the markerless method, the object identification unit 122 acquires the type information of the object from the type information database using the feature amount of the detected object. The type information database is a database in which the type information of the object is related to the feature amount of the object. The type information database is created by machine learning of the feature amount of the object. The type information database may be either an external database provided to another computer, or an internal database provided to the AR device 100.

The superimposing information collection unit 123 acquires the object information concerning the object as superimposing information 192 based on the type of the object identified by the object identification unit 122. For example, the object information is described in JSON format.

The superimposing information collection unit 123 may acquire information other than the object information as the superimposing information 192. For example, the superimposing information collection unit 123 may acquire information related to the current date and time, position, climate, and so on as the superimposing information 192.

For example, when the object is detected by the marker method, the superimposing information collection unit 123 reads object information from the marker.

For example, when the object is detected by the markerless method, the superimposing information collection unit 123 acquires the object information or URI from the object information database using the type information of the object. The object information database is a database in which the object information or URI is related to the type information. The object information database may be either an external database or an internal database. URI is an abbreviation of Uniform Resource Identifier. URI may be replaced with URL (Uniform Resource Locator).

When a URL is acquired from the object information database, the superimposing information collection unit 123 acquires the object information from a storage area indicated by the URI. The storage area indicated by the URI may be a storage area provided to either the storage device included in another computer or a storage device included in the AR device 100.

According to Embodiment 2, the superimposing information concerning the object shown on the photographic image 191 can be acquired.

### Embodiment 3

An embodiment will be described where a superimposing information acquisition unit 120 acquires, as superimposing information 192, information concerning an information processing image shown in a display area.

Matters that are not described in Embodiment 1 and Embodiment 2 will mainly be described hereinafter. Matters whose description is omitted are equivalent to those of Embodiment 1 or Embodiment 2.

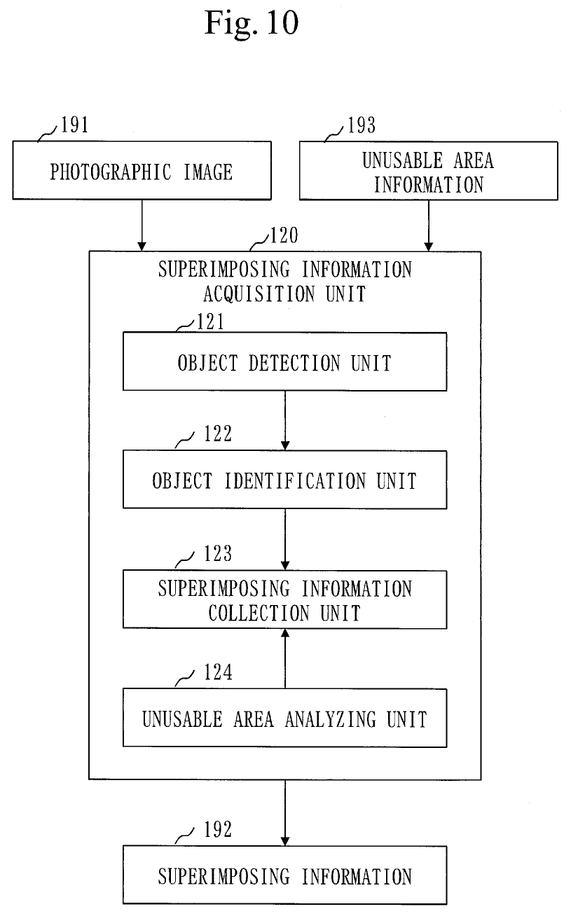

FIG. 10 is a functional configuration diagram of the superimposing information acquisition unit 120 according to Embodiment 3.

The functional configuration of the superimposing information acquisition unit 120 according to Embodiment 3 will be described with referring to FIG. 10. The functional configuration of the superimposing information acquisition unit 120 may be different from the functional configuration in FIG. 10.

The superimposing information acquisition unit 120 is provided with an unusable area analyzing unit 124, in addition to the function described in Embodiment 2 (see FIG. 9).

Based on unusable area information 193, the unusable area analyzing unit 124 analyzes an information processing image 300 shown in an unusable area 390.

For example, the unusable area analyzing unit 124 detects an icon from the information processing image 300 by analyzing the information processing image 300.

The icon is linked to an electronic file (including an application program). The icon is a picture representing the contents of the linked electronic file. Sometimes a character string is added to the picture.

Based on the analysis result of the information processing image 300, a superimposing information collection unit 123 collects information related to the information processing image 300, as the superimposing information 192.

For example, the superimposing information collection unit 123 collects information related to the electronic file distinguished by the icon detected from the information processing image 300, as the superimposing information 192. The application program is an example of the electronic file.

For example, the superimposing information collection unit 123 collects application information from an application information database in which application information is related to the icon. The application name and version number are examples of information included in the application information. The application information database may be any one of a database provided to an information processing device 200, a database provided to an AR device 100, and a database provided to another computer.

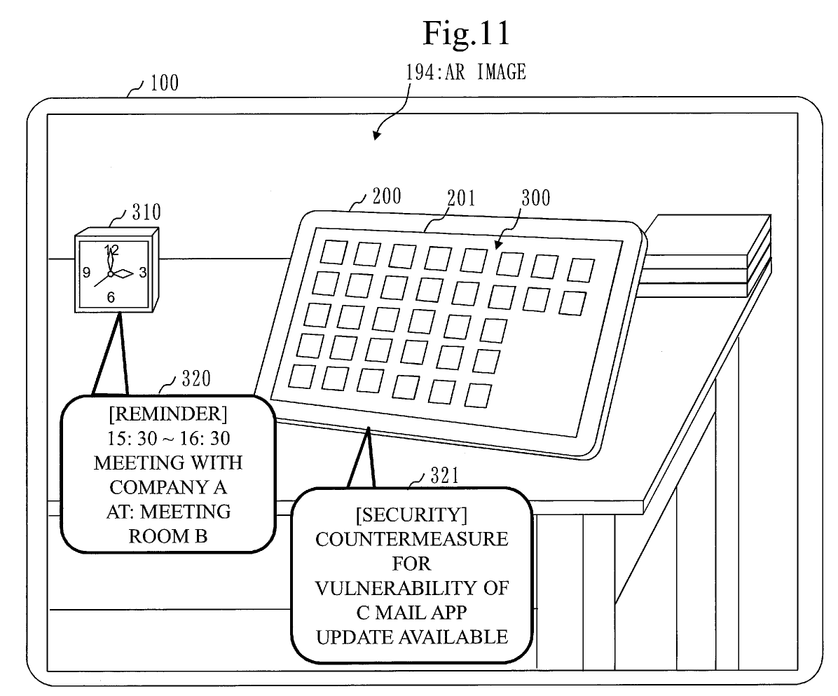

FIG. 11 is a diagram illustrating an example of an AR image 194 according to Embodiment 3.

Referring to FIG. 11, the AR image 194 includes an information illustration 321 illustrating the application information and update information as the superimposing information 192. The update information is information indicating whether an update for the application program is available.

For example, the unusable area analyzing unit 124 detects a square icon from the information processing image 300.

Then, the superimposing information collection unit 123 acquires the application information concerning the application program which is discriminated by the detected icon, from the application information database. The superimposing information collection unit 123 also acquires the update information from an application management server with using the application name and version number included in the acquired application information. The application management server is a server for managing the application program.

According to Embodiment 3, the superimposing information 192 concerning an image displayed in the display area of the display device being a subject can be acquired.

### Embodiment 4

An unusable area selection unit 130 of an AR device 100 will be described.

Matters that are not described in Embodiments 1 to 3 will mainly be described hereinafter. Matters whose description is omitted are equivalent to those of Embodiments 1 to 3.

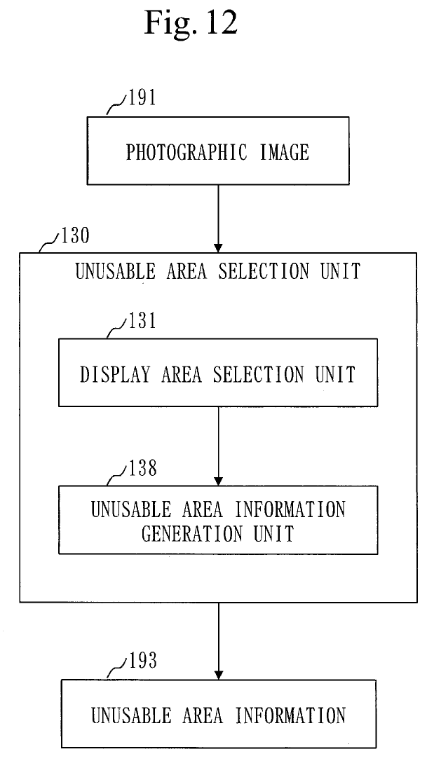

FIG. 12 is a functional configuration diagram of the unusable area selection unit 130 according to Embodiment 4.

The functional configuration of the unusable area selection unit 130 according to Embodiment 4 will be described with referring to FIG. 12. The functional configuration of the unusable area selection unit 130 may be different from the functional configuration in FIG. 12.

The unusable area selection unit 130 is provided with a display area selection unit 131 and an unusable area information generation unit 138.

The display area selection unit 131 selects a display area 201 from a photographic image 191.

The unusable area information generation unit 138 creates unusable area information 193 which indicates the display area 201 as an unusable area 390. Where there are a plurality of display areas 201, the unusable area information generation unit 138 creates unusable area information 193 for each display area 201.

For example, the display area selection unit 131 selects the display area 201 as follows.

When a liquid crystal display is photographed with a digital camera, an interference fringes occur on that portion of the liquid crystal display where the display area 201 is shown. The interference fringes are a stripe pattern formed of periodical bright and dark portions. The interference fringes are also called moiré.

The interference fringes occur because of a difference existing between the resolution of the liquid crystal display and the resolution of the digital camera.

Hence, the display area selection unit 131 selects an area where the interference fringes are shown, as the display area 201. For example, the display area selection unit 131 selects the display area 201 using a Fourier transformation formula representing the bright and dark portions of the interference fringes.

For example, the display area selection unit 131 selects the display area 201 as follows.

Many display devices are provided with a light-emitting function called backlight in order to increase the visibility of the display area 201. Therefore, when something is displayed on the display area 201, the luminance of the display area 201 is high.

Hence, the display area selection unit 131 selects an area where the luminance is higher than a luminance threshold, as the display area 201.

For example, the display area selection unit 131 selects the display area 201 as follows.

A display device using a cathode-ray tube carries out a display process for each scanning line. Scanning lines being displayed while the camera shutter is open are bright on the photographic image 191, while the remaining scanning lines are dark on the photographic image 191. As a result, a stripe pattern formed of bright scanning lines and dark scanning lines appears on the photographic image 191.

As the time duration where the camera shutter is open is not synchronized with the display cycle of the scanning lines, each time photographing is carried out, the positions of the bright scanning lines and dark scanning lines change. Namely, the positions of the stripes in the pattern appearing on the photographic image 191 change each time photographing is carried out. Therefore, a stripe pattern that moves within the display area 201 of the display device appears on the plurality of photographic image 191 that are photographed consecutively.

Thus, the display area selection unit 131 selects the area where the stripe pattern moves, from each photographic image 191 by using the plurality of photographic images 191 which are photographed consecutively. The selected area is the display area 201.

For example, the display area selection unit 131 selects the display area 201 as follows.

If a video image whose contents are changing is displayed on the display device, the image displayed in the display area 201 of the display device changes each time the photographic image 191 is photographed.

Using the plurality of photographic images 191 being photographed consecutively, the display area selection unit 131 selects a changing area from each photographic image 191. The selected area is the display area 201. In order to separate a change in image displayed in the display area 201 and a change in the photographic image 191 caused by the motion of the AR device 100 from each other, the display area selection unit 131 detects the motion of the AR device 100 by a gyrosensor.

According to Embodiment 4, the display area being a subject can be selected as an unusable area.

### Embodiment 5

An unusable area selection unit 130 of an AR device 100 will be described. Matters that are not described in Embodiments 1 to 4 will mainly be described hereinafter. Matters whose description is omitted are equivalent to those of Embodiments 1 to 4.

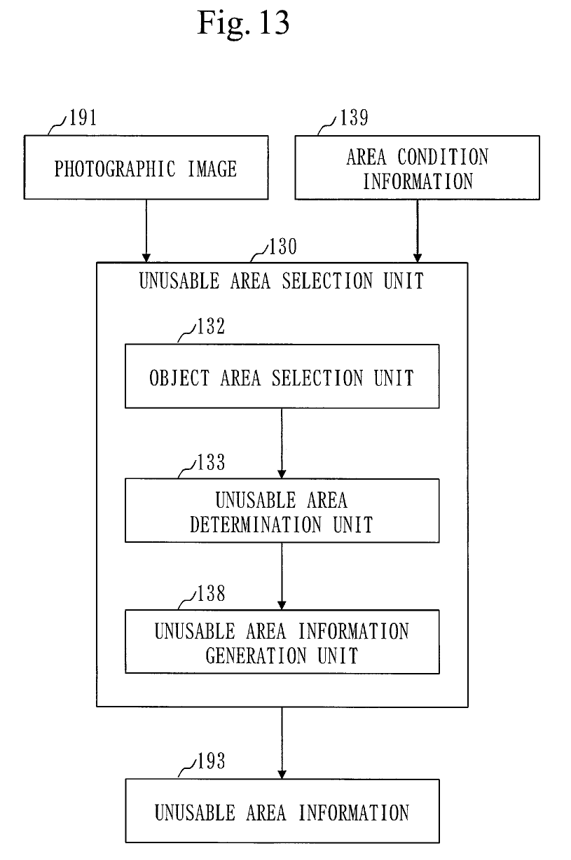

FIG. 13 is a functional configuration diagram of the unusable area selection unit 130 according to Embodiment 5.

The functional configuration of the unusable area selection unit 130 according to Embodiment 5 will be described with referring to FIG. 13. The functional configuration of the unusable area selection unit 130 may be a functional configuration different from that in FIG. 13.

The unusable area selection unit 130 generates the unusable area information 193 based on area condition information 139.

The unusable area selection unit 130 is provided with an object area selection unit 132, an unusable area determination unit 133, and an unusable area information generation unit 138.

The unusable area information generation unit 138 generates unusable area information 193 indicating an unusable area 390. Where there are a plurality of unusable areas 390, the unusable area information generation unit 138 generates a plurality of pieces of unusable area information 193.

The area condition information 139 is information indicating the condition of an object area 391 where an object is displayed. In this case, the object is displayed in a display area 201 of an information processing device 200. For example, an icon 330 and window 340 are examples of the object. The area condition information 139 is an example of data stored in a device storage unit 190.

For example, the area condition information 139 indicates the following contents as the condition of the object area 391.

A general information processing device 200 displays, as GUI, a plurality of icons 330 linked to electronic files (application programs included), in a display area 201. GUI is an abbreviation of graphical user interface. The icons 330 are pictures expressing the contents of the linked electronic files. Sometimes a character string is added to the picture of the icon 330.

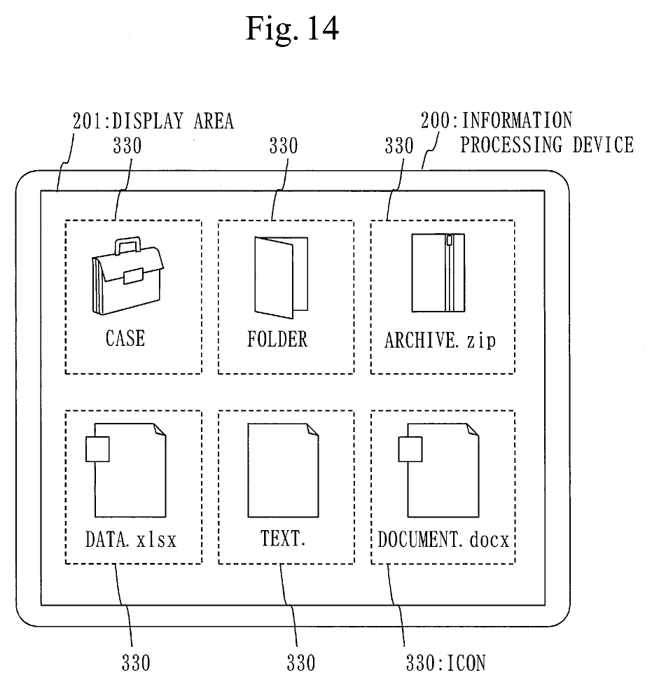

FIG. 14 is a diagram illustrating an example of the plurality of icons 330 displayed in the display area 201 according to Embodiment 5. In FIG. 14, six objects surrounded by broken lines are the icons 330.

As illustrated in FIG. 14, usually, the plurality of icons 330 are arranged regularly. For example, the plurality of icons 330 are arranged at constant spaces so that they will not overlap each other.

The area condition information 139 indicates information concerning the icons 330, as the condition of the object area 391. For example, the area condition information 139 indicates a plurality of images used as the icons 330. Alternatively, for example, the area condition information 139 is information indicating the threshold of the size of the icons 330, the threshold of the mutual distances among the icons 330, and the threshold of the ratio of the picture size to the character string size.

For example, the area condition information 139 indicates the following contents as the condition of the object area 391.

The general information processing device 200 displays a screen called a window 340 in the display area 201 when a specific application program is activated. Word processing software and folder browser software are examples of the application program that displays the window 340. The window 340 is an example of GUI.

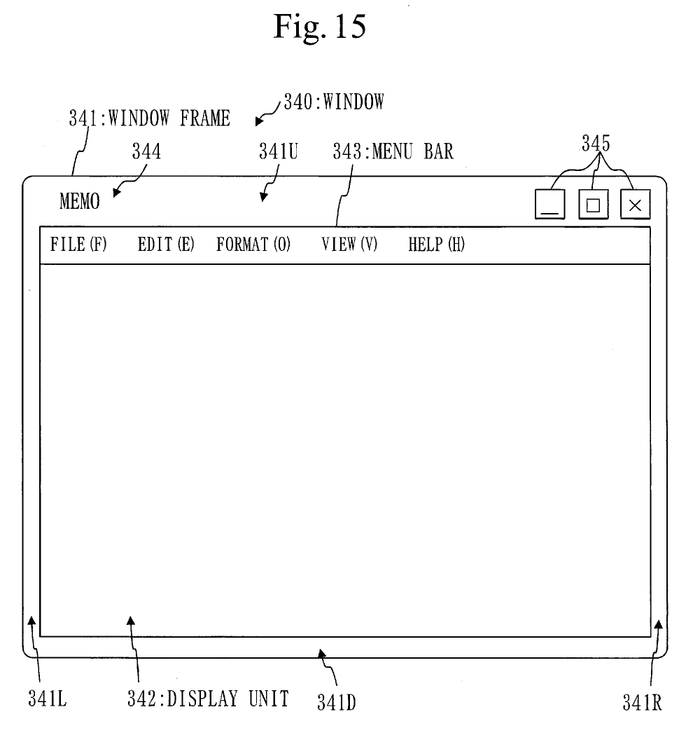

FIG. 15 is a diagram illustrating an example of the window 340 according to Embodiment 5.

As illustrated in FIG. 15, usually, the window 340 has a square shape. The window 340 has a display part 342 which displays some message, and a window frame 341 surrounding the display part 342. The display part 342 has a menu bar 343 on its upper portion.

The upper portion, the lower portion, the left-side portion, and the right-side portion of the window frame 341 will be called a frame upper portion 341U, a frame lower portion 341D, a frame left portion 341L, and a frame right portion 341R, respectively.

The frame upper portion 341U is wider than the other portions of the window frame 341 and is provided with a title 344, button objects 345, and so on. The minimize button, maximize button, end button, and so on are examples of the button objects 345.

The area condition information 139 indicates the feature of the window frame 341 as the condition of the object area 391. For example, the feature of the window frame 341 is: the shape is square, the frame upper portion 341U is wider than the other portions, the other portions have the same width, the frame upper portion 341U has a character string on it, and the frame upper portion 311 has the button objects 345 on it. The frame upper portion 341U may be replaced with the frame lower portion 341D, frame left portion 341L, or frame right portion 341R.

Based on the area condition information 139, the object area selection unit 132 selects the object area 391 from a photographic image 191.

If the area condition information 139 shows information on the icons 330, for each icon 330 shown on the photographic image 191, the object area selection unit 132 selects the area where the icon 330 is shown, as an object area 391.

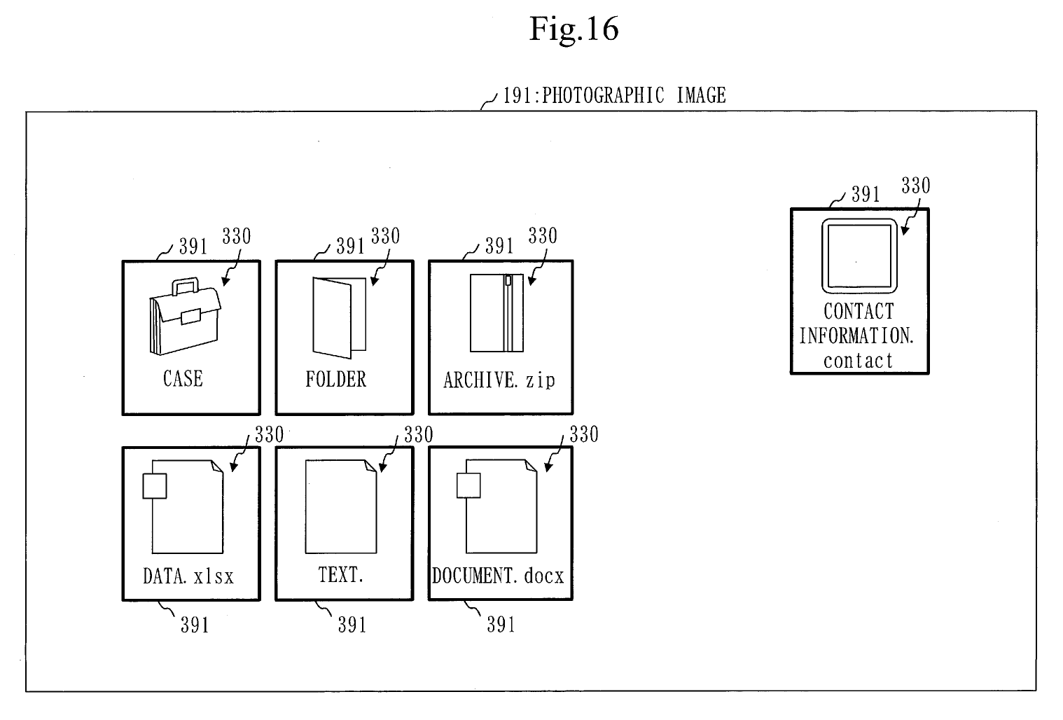

FIG. 16 is a diagram illustrating part of an example of the photographic image 191 according to Embodiment 5.

Referring to FIG. 16, the photographic image 191 shows seven icons 330. In this case, the object area selection unit 132 selects seven object areas 391.

If the area condition information 139 indicates the feature of the window frame 341, for each window 340 shown on the photographic image 191, the object area selection unit 132 selects the area where the window 340 is shown, as the object area 391.

For example, the object area selection unit 132 detects a square edge included in the photographic image 191, as the window frame 341.

For example, the object area selection unit 132 detects the window frame 341 and the button objects 345 based on the color of the window frame 341.

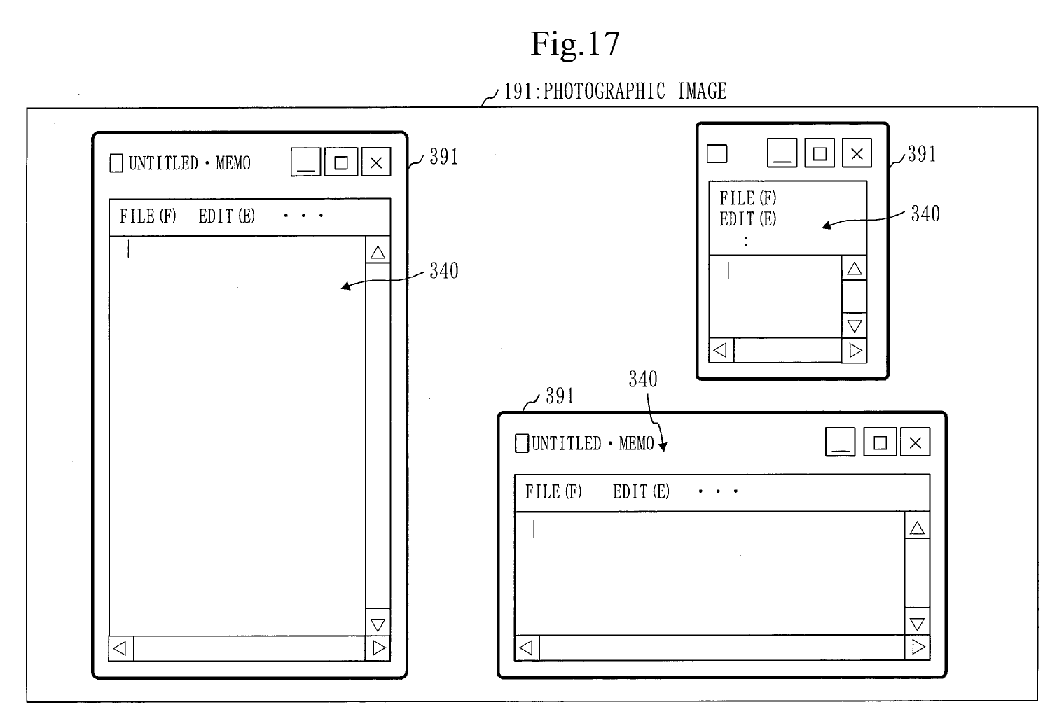

FIG. 17 is a diagram illustrating part of an example of the photographic image 191 according to Embodiment 5.

Referring to FIG. 17, the photographic image 191 shows three windows 340. In this case, the object area selection unit 132 selects three object areas 391.

The unusable area determination unit 133 determines the unusable area 390 based on the object areas 391.

At this time, the unusable area determination unit 133 groups the object areas 391 based on the distances among the object areas 391, and determines the unusable area 390 for each group of object areas 391.

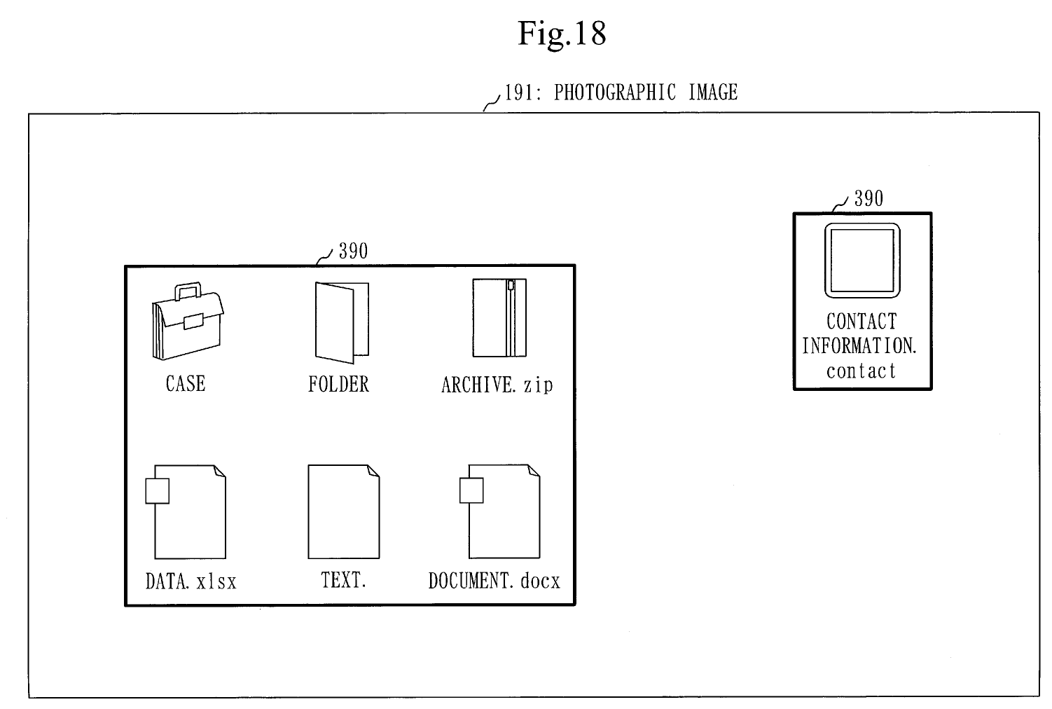

FIG. 18 is a diagram illustrating an example of the unusable area 390 according to Embodiment 5.

For example, the photographic image 191 (see FIG. 16) includes seven object areas 391. The mutual distances among the six object areas 391 on the left side are shorter than a distance threshold. The distances between one object area 391 on the right side and the six object areas 391 on the left side are longer than the distance threshold.

In this case, the unusable area determination unit 133 determines an area surrounded by a square frame enclosing the six object areas 391 on the left side, as an unusable area 390 (see FIG. 18). The unusable area determination unit 133 also determines one object area 391 on the right side as the unusable area 390.

The unusable area 390 on the right side and the unusable area 390 on the left side are assumed to represent display areas 201 of different display devices.

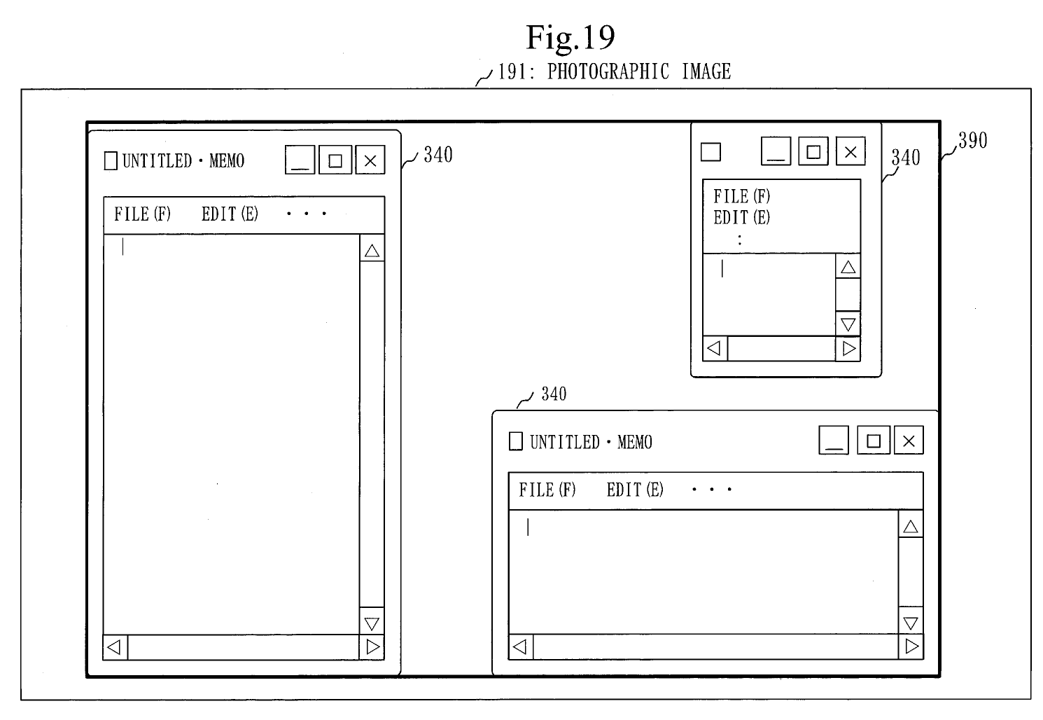

FIG. 19 is a diagram illustrating an example of the unusable area 390 according to Embodiment 5.

For example, the photographic image 191 in FIG. 17 includes the three object areas 391. The mutual distances among the three object areas 391 are shorter than the distance threshold.

In this case, as illustrated in FIG. 19, the unusable area determination unit 133 determines an area in a square frame enclosing the three object areas 391, as an unusable area 390.

The three object areas 391 are assumed to be included in a display area 201 of one display device.

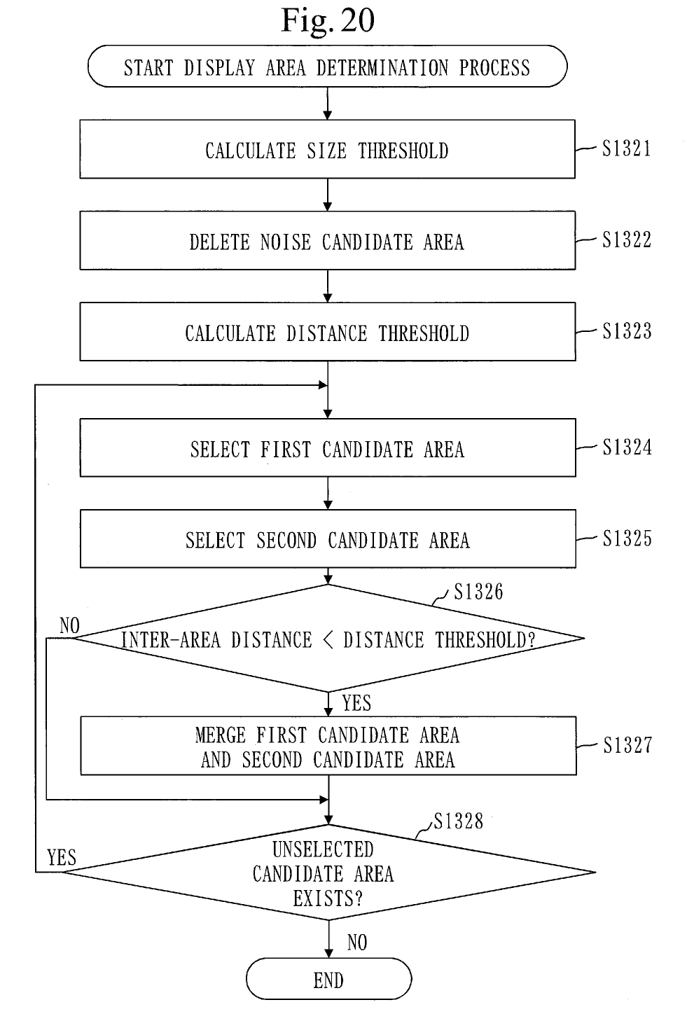

FIG. 20 is a flowchart illustrating an unusable area determination process of the unusable area determination unit 133 according to Embodiment 5.

The unusable area determination process of the unusable area determination unit 133 according to Embodiment 5 will be described with referring to FIG. 20. Note that the unusable area determination process may be a process different from that in FIG. 20.

In S1321, the unusable area determination unit 133 calculates the sizes of the plurality of object area 391 and calculates the size threshold of the object areas 391 based on the individual sizes.

For example, the unusable area determination unit 133 calculates the average value of the sizes of the plurality of object areas 391, or the average value multiplied by a size coefficient, as the size threshold. If the object area 391 is the area of an icon 330, the longitudinal, transversal, or oblique length of the icon 330 is an example of the size of the object area 391. If the object area 391 is the area of a window 340, the width of the frame upper portion 341U of the window frame 341 is an example of the size of the object area 391.

After S1321, the process proceeds to S1322.

In S1322, the unusable area determination unit 133 deletes an object area 391 smaller than the size threshold, from the plurality of the object areas 391. The object area 391 to be deleted is assumed to be a noise area which is not actually an object area 391 but was selected erroneously.

For example, if the size threshold of the icon 330 is 0.5 cm (centimeter), an object shown in an object area 391 having a longitudinal length of 1 cm is assumed to be an icon 330, while an object shown in an object area 391 having a longitudinal length of 0.1 cm is not assumed to be an icon 330. Hence, the unusable area determination unit 133 deletes the object area 391 having the longitudinal length of 0.1 cm.

After S1322, the process proceeds to S1323.

In the process of S1323 onward, the plurality of object areas 391 do not include the object area 391 deleted in S1322.

In S1323, the unusable area determination unit 133 calculates the mutual distances among the plurality of object area 391 and calculates the distance threshold based on the mutual distances.

For example, the unusable area determination unit 133 selects a next object area 391 for each object area 391, and calculates the distance between the selected object areas 391. Then, the unusable area determination unit 133 calculates the average value of the distances among the object areas 391, or the average value multiplied by a distance coefficient, as the distance threshold.

After S1323, the process proceeds to S1324.

In S1324, the unusable area determination unit 133 selects one object area 391 being not selected as the first object area 391, from the plurality of object areas 391.

The object area 391 selected in S1324 will be called the first object area 391 hereinafter.

After S1324, the process proceeds to S1325.

In S1325, the unusable area determination unit 133 selects an object area 391 located next to the first object area 391 from the plurality of object areas 391. For example, the unusable area determination unit 133 selects an object area 391 nearest to the first object area 391.

The object area 391 selected in S1325 will be called the second object area 391 hereinafter.

After S1325, the process proceeds to S1326. If there is no second object area 391, that is, if there is no object area 391 left other than the first object area 391, the unusable area determination process ends (not illustrated).

In S1326, the unusable area determination unit 133 calculates the inter-area distance between the first object area 391 and the second object area 391 and compares the calculated inter-area distance with the distance threshold.

If the inter-area distance is less than the distance threshold (YES), the process proceeds to S1327.

If the inter-area distance is equal to or larger than the distance threshold (NO), the process proceeds to S1328.

In S1327, the unusable area determination unit 133 generates a new object area 391 by merging the first object area 391 and second object area 391. Namely, the first object area 391 and the second object area 391 disappear and a new object area 391 is generated instead. The new object area 391 is an area within a square frame enclosing the first object area 391 and the second object area 391. For example, the new object area 391 is a minimum rectangular area including the first object area 391 and the second object area 391.

After S1327, the process proceeds to S1328.

In S1328, the unusable area determination unit 133 checks whether there is an unselected object area 391 not being selected as the first object area 391. The new object area 391 generated in S1327 is an unselected object area 391.

If there is an unselected object area 391 (YES), the process returns to S1324.

If there is no unselected object area 391 (NO), the unusable area determination process ends.

The object area 391 that is left after the unusable area determination process is the unusable area 390.

The unusable area determination unit 133 may execute a new unusable area determination process targeting at the object area 391 deleted in S1322 because, where a display device exists far away from the AR device 100, it is likely that an area such as an icon 330 displayed on the display area 201 of this display device may be judged as a noise area and be deleted.

Hence, the display area 201 of a display device located near the AR device 100 is determined as the unusable area 390 in the first unusable area determination process, and the display area 201 of the display device far away from the AR device 100 is determined as the unusable area 390 in the second and following unusable area determination processes.

According to Embodiment 5, of the display area of a display device being a subject, an object area where the object is displayed can be selected as an unusable area. Superimposing information can be superimposed on the display area other than the object area. Namely, the image area where the superimposing information can be superimposed can be enlarged.

### Embodiment 6

An embodiment will be described in which a display area 201 is determined based on the bezel of a display device.

Matters that are not described in Embodiments 1 to 5 will mainly be described hereinafter. Matters whose description is omitted are equivalent to those of Embodiments 1 to 5.

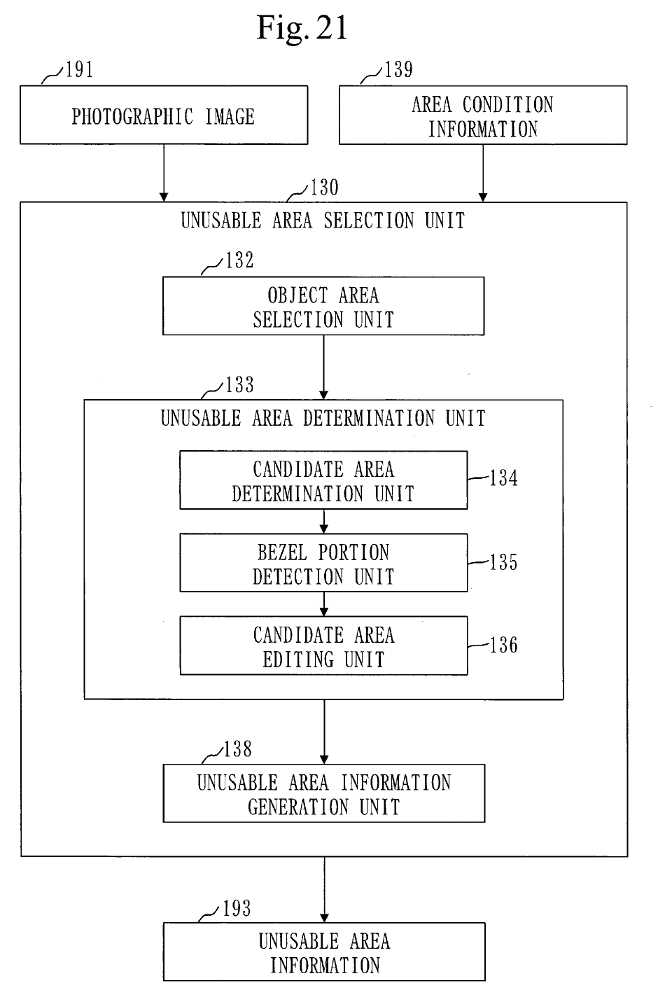

FIG. 21 is a functional configuration diagram of an unusable area selection unit 130 according to Embodiment 6.

The functional configuration of the unusable area selection unit 130 according to Embodiment 6 will be described with referring to FIG. 21. The functional configuration of the unusable area selection unit 130 may be a functional configuration different from that of FIG. 21.

The unusable area selection unit 130 is provided with an object area selection unit 132, an unusable area determination unit 133, and an unusable area information generation unit 138.

The object area selection unit 132 and the unusable area information generation unit 138 are equivalent to those of Embodiment 5 (see FIG. 13).

The unusable area determination unit 133 is provided with a candidate area determination unit 134, a bezel portion detection unit 135, and a candidate area editing unit 136.

The candidate area determination unit 134 determines a candidate for an unusable area 390 by the unusable area determination process (see FIG. 20) described in Embodiment 5. The candidate for the unusable area 390 will be called a candidate area 392 hereinafter.

The bezel portion detection unit 135 detects a bezel portion 393 corresponding to the bezel of the display device, from a photographic image 191. The bezel is a frame that surrounds the display area 201.

For example, the bezel portion detection unit 135 detects a square edge as the bezel portion 393. The bezel portion detection unit 135 may detect by edge detection a neck portion supporting the display device placed on a desk, and detect a square edge above the detected neck portion as the bezel portion 393.

For example, the bezel portion detection unit 135 detects a portion coinciding with a three-dimensional model expressing the three-dimensional shape of the bezel, as the bezel portion 393. The three-dimensional model is an example of data stored in a device storage unit 190.

The candidate area editing unit 136 determines the unusable area 390 by editing the candidate area 392 based on the bezel portion 393.

At this time, the candidate area editing unit 136 selects, for the individual bezel portions 393, the candidate areas 392 surrounded by the corresponding bezel portions 393, and merges the candidate areas 392 surrounded by the bezel portions 393, thereby determining the unusable area 390.

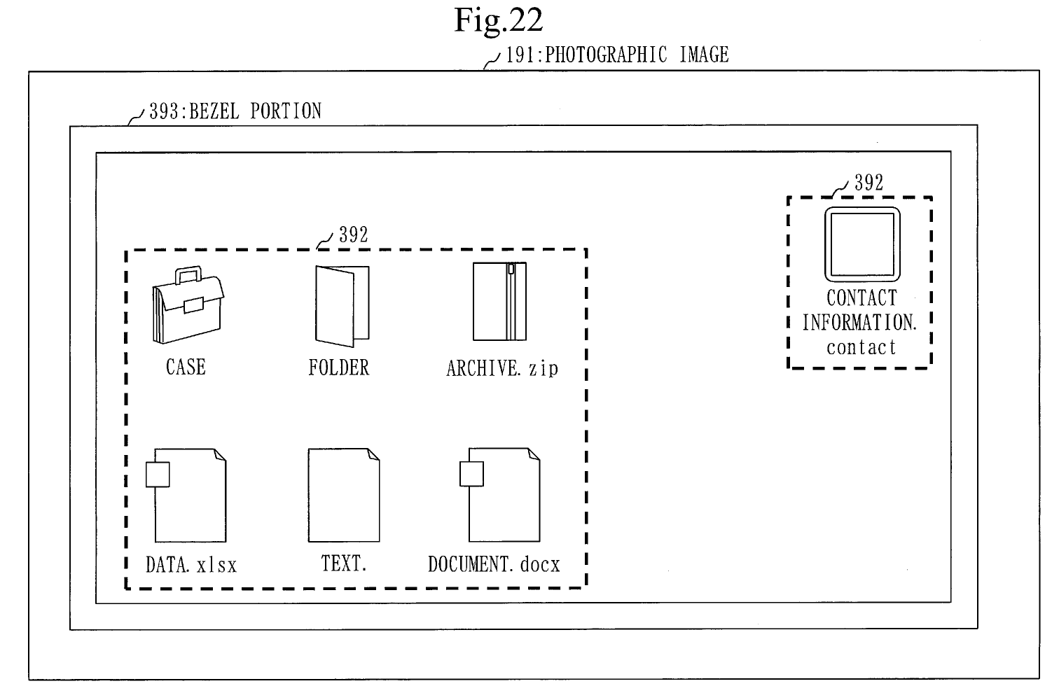

FIG. 22 is a diagram illustrating an example of the bezel portion 393 according to Embodiment 6.

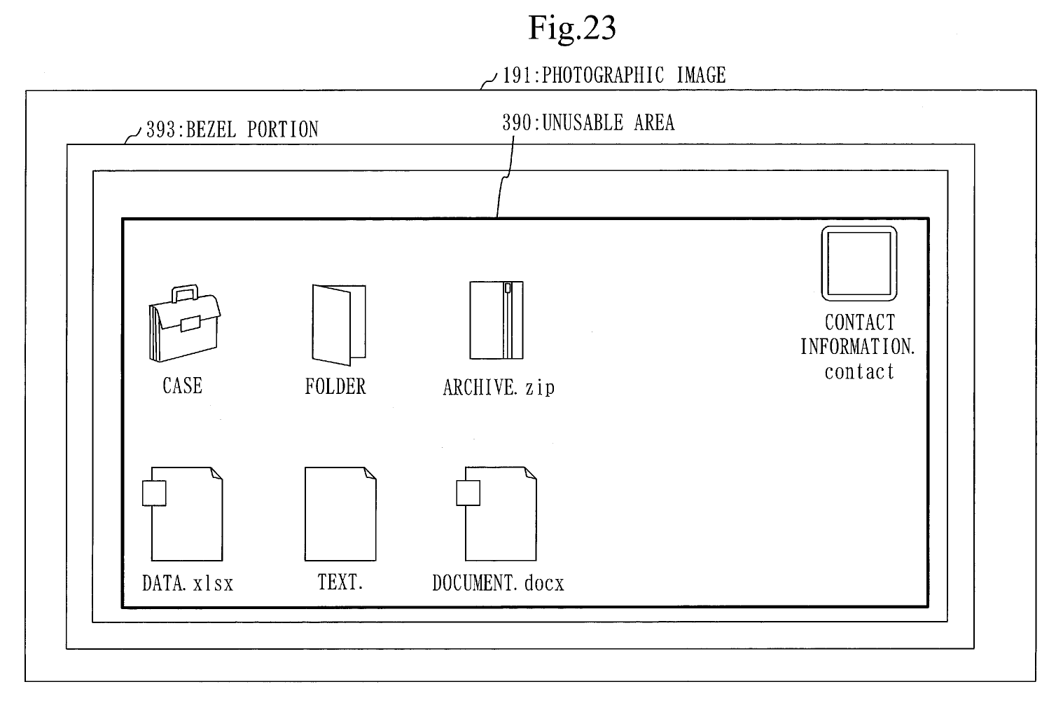

FIG. 23 is a diagram illustrating an example of the unusable area 390 according to Embodiment 6.

Referring to FIG. 22, one bezel portion 393 is detected from the photographic image 191. This bezel portion 393 surrounds two candidate areas 392.

In this case, the candidate area editing unit 136 generates, in the bezel portion 393, a square unusable area 390 including two candidate areas 392 (see FIG. 23).

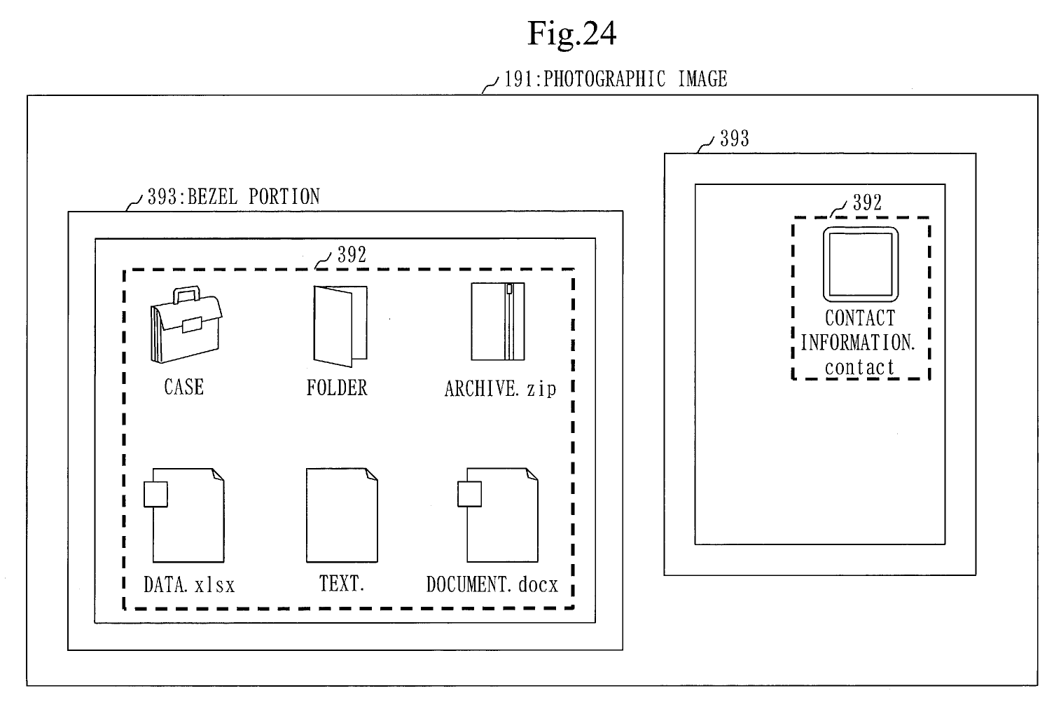

FIG. 24 is a diagram illustrating examples of the bezel portion 393 according to Embodiment 6.

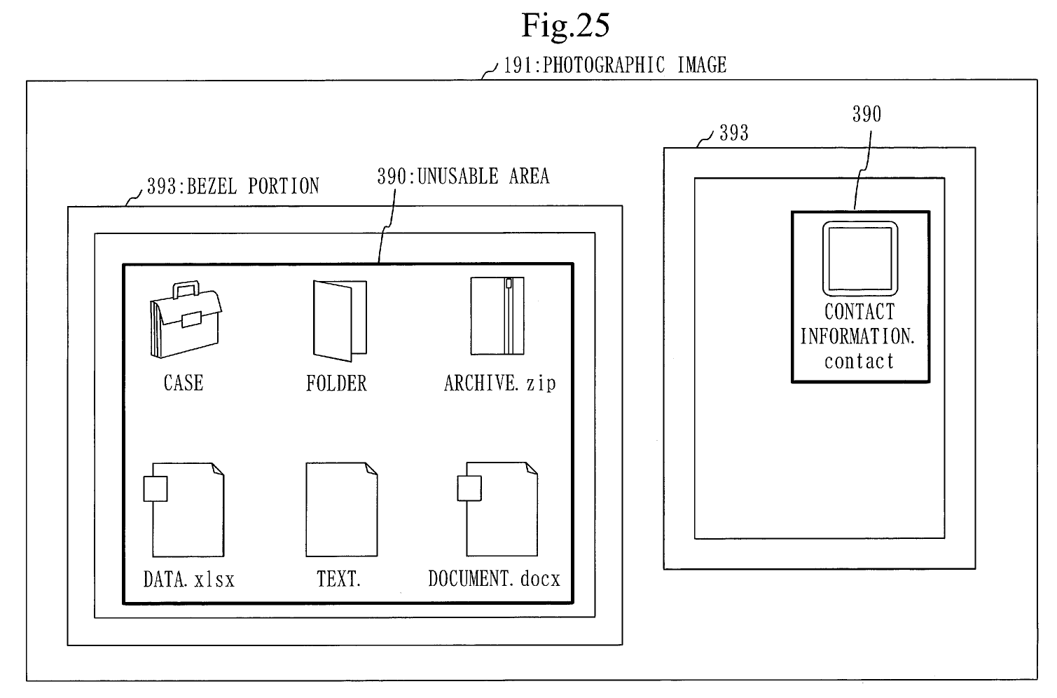

FIG. 25 is a diagram illustrating examples of the unusable area 390 according to Embodiment 6.

Referring to FIG. 24, two bezel portions 393 are detected from the photographic image 191. Each bezel portion 393 surrounds one candidate area 392.

In this case, the candidate area editing unit 136 determines each candidate area 392 as an unusable area 390 (see FIG. 25).

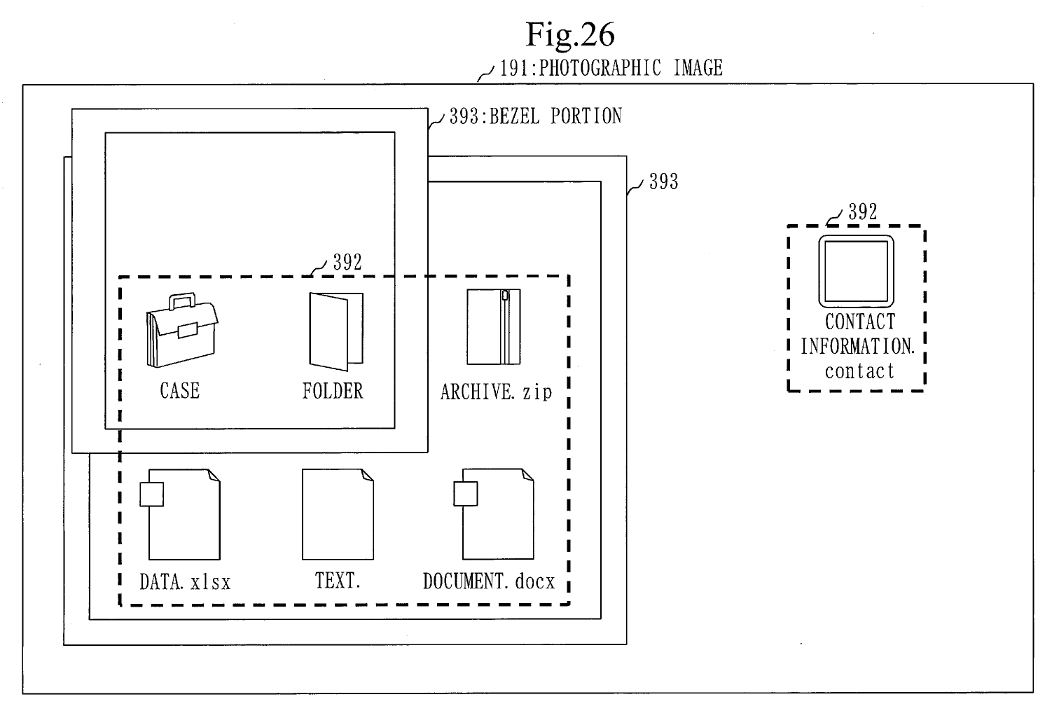

FIG. 26 is a diagram illustrating examples of the bezel portion 393 according to Embodiment 6.

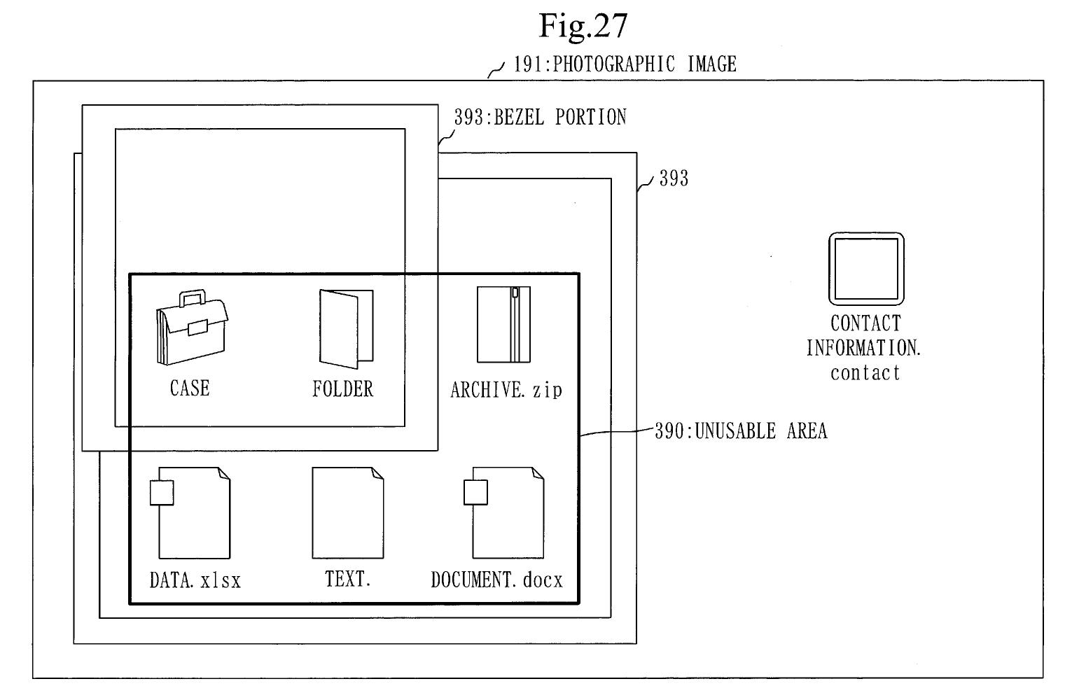

FIG. 27 is a diagram illustrating an example of the unusable area 390 according to Embodiment 6.

Referring to FIG. 26, the two bezel portions 393 which overlap partly are detected from the photographic image 191. One bezel portion 393 surrounds part of the candidate area 392. The other bezel portion 393 surrounds the remaining portion of the candidate area 392.

In this case, the candidate area editing unit 136 determines the candidate area 392 surrounded by the two bezel portion 393, as the unusable area 390 (see FIG. 27).

Also, the candidate area editing unit 136 does not determine a candidate area 392 not surrounded by any bezel portion 393, as the unusable area 390. However, the candidate area editing unit 136 may nevertheless determine this candidate area 392 as the unusable area 390.

The candidate area editing unit 136 may determine the entire portion of the image area surrounded by the bezel portion 393 that surrounds the candidate area 392 entirely or partly, as the unusable area 390.

According to Embodiment 6, the display area 201 can be determined based on the bezel of the display device. Hence, a more appropriate unusable area can be selected.

### Embodiment 7

An AR image generation unit 140 of an AR device 100 will be described.

Matters that are not described in Embodiments 1 to 6 will mainly be described hereinafter. Matters whose description is omitted are equivalent to those of Embodiments 1 to 6.

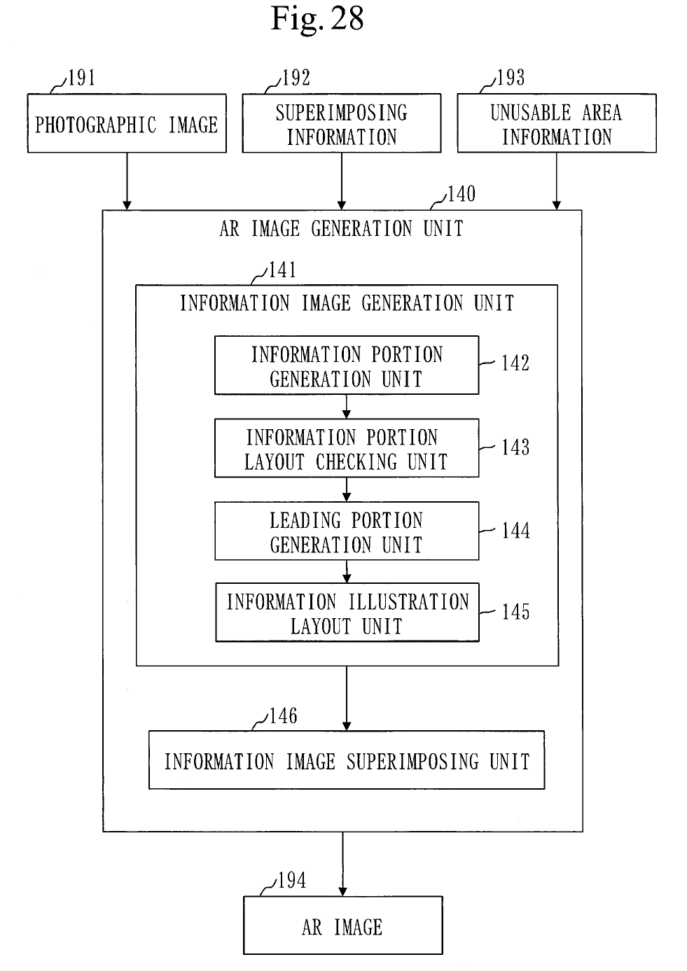

FIG. 28 is a functional configuration diagram of the AR image generation unit 140 according to Embodiment 7.

The functional configuration of the AR image generation unit 140 according to Embodiment 7 will be described with referring to FIG. 28. The functional configuration of the AR image generation unit 140 may be a functional configuration different from that in FIG. 28.

The AR image generation unit 140 is provided with an information image generation unit 141 and an information image superimposing unit 146.

The information image generation unit 141 generates an information image 329 including an information illustration 320 describing superimposing information 192.

The information image superimposing unit 146 generates an AR image 194 by superimposing the information image 329 over a photographic image 191.

The information image generation unit 141 is provided with an information portion generation unit 142, an information portion layout checking unit 143, a leader portion generation unit 144, and an information illustration layout unit 145.

The information portion generation unit 142 generates an information part illustration 322 showing the superimposing information 192 out of the information illustration 320.

Based on unusable area information 193, the information portion layout checking unit 143 checks whether or not the information part illustration 322 can be arranged on the photographic image 191 to avoid an unusable area 390. If the the information part illustration 322 cannot be arranged on the photographic image 191 to avoid the unusable area 390, the information portion generation unit 142 generates an information part illustration 322 again.

The leader portion generation unit 144 generates a leader illustration 323 being an illustration in which the information part illustration 322 is associated with an object area showing an object related to the superimposing information 192.

The information illustration layout unit 145 generates the information image 329 in which an information illustration 320 including the information part illustration 322 and leader illustration 323 is arranged to avoid the unusable area 390.

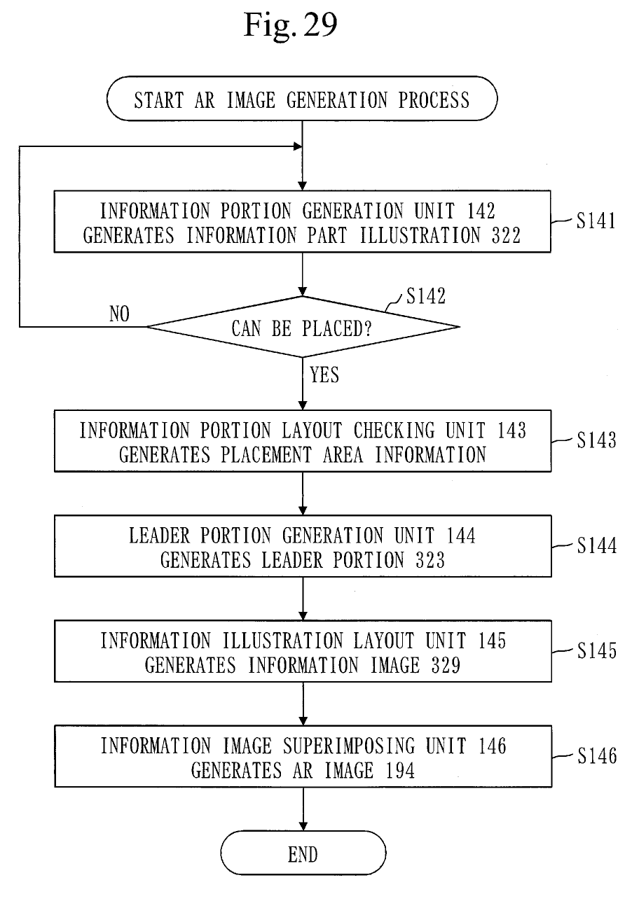

FIG. 29 is a flowchart illustrating an AR image generation process of the AR image generation unit 140 according to Embodiment 7.

The AR image generation process of the AR image generation unit 140 according to Embodiment 7 will be described with referring to FIG. 29. The AR image generation process may be a process different from that in FIG. 29.

In S141, the information portion generation unit 142 generates the information part illustration 322 being an illustration representing the contents of the superimposing information 192. Where there are a plurality of pieces of superimposing information 192, the information portion generation unit 142 generates an information part illustration 322 for each piece of superimposing information 192.

After S141, the process proceeds to S142.

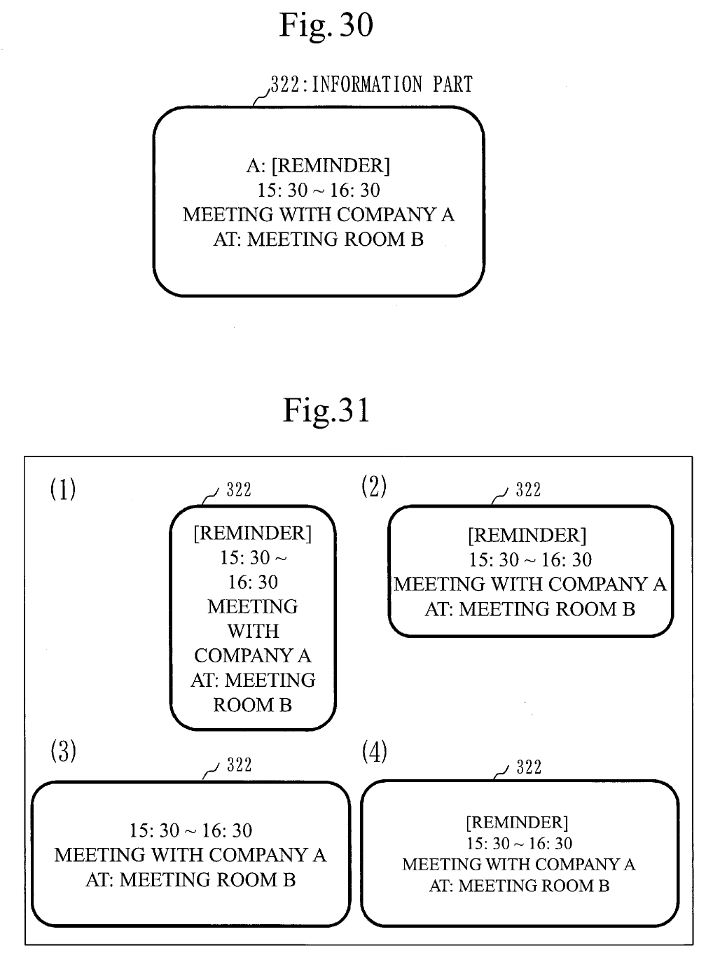

FIG. 30 is a diagram illustrating an example of the information part illustration 322 according to Embodiment 7.

For example, the information portion generation unit 142 generates an information part illustration 322 as illustrated in FIG. 30. The information part illustration 322 is formed by surrounding a character string expressing the contents of the superimposing information 192 with a frame.

Back to FIG. 29, the explanation resumes with S142.

In S142, based on the unusable area information 193, the information portion layout checking unit 143 checks whether or not the information part illustration 322 can be arranged in the photographic image 191 to avoid the unusable area 390. Where there are a plurality of information part illustrations 322, the information portion layout checking unit 143 carries out checking for each information part illustration 322.

If the information part illustration 322 overlaps the unusable area 390 no matter where the information part illustration 322 is arranged in the photographic image 191, the information part illustration 322 cannot be arranged in the photographic image 191 to avoid the unusable area 390.

If the information part illustration 322 can be arranged in the photographic image 191 to avoid the unusable area 390 (YES), the process proceeds to S143.

If the information part illustration 322 cannot be arranged in the photographic image 191 to avoid the unusable area 390 (NO), the process returns to S141.

When the process returns to S141, the information portion generation unit 142 generates an information part illustration 322 again.

For example, the information portion generation unit 142 deforms the information part illustration 322 or reduces the information part illustration 322.

FIG. 31 is a diagram illustrating modifications of the information part illustration 322 according to Embodiment 7.

For example, the information portion generation unit 142 generates an information part illustration 322 (see FIG. 30) again as illustrated in (1) to (4) of FIG. 31.

In (1) of FIG. 31, the information portion generation unit 142 deforms the information part illustration 322 by changing the aspect ratio of the information part illustration 322.

In (2) of FIG. 31, the information portion generation unit 142 reduces the information part illustration 322 by deleting blank around the character string (blank included in the information part illustration 322).

In (3) of FIG. 31, the information portion generation unit 142 reduces the information part illustration 322 by changing or deleting part of the character string.

In (4) of FIG. 31, the information portion generation unit 142 reduces the information part illustration 322 by downsizing the characters in the character string.

Where the information part illustration 322 is an illustration expressed three-dimensionally, the information portion generation unit 142 may reduce the information part illustration 322 by changing the information part illustration 322 to a two-dimensional illustration. For example, if the information part illustration 322 is a shadowed illustration, the information portion generation unit 142 deletes the shadow portion from the information part illustration 322.

Back to FIG. 29, the explanation resumes with S143.

In S143, the information portion layout checking unit 143 generates layout area information indicating a layout area where the information part illustration 322 can be arranged. Where there are a plurality of information part illustrations 322, the information portion layout checking unit 143 generates layout area information for each information part illustration 322.

Where there are plurality of candidates for the layout area where the information part illustration 322 can be arranged, the information portion layout checking unit 143 selects the layout area based on object area information.

The object area information is information indicating an object area showing an object related to the information part illustration 322. The object area information can be generated by the object detection unit 121 of the superimposing information acquisition unit 120.

For example, the information portion layout checking unit 143 selects a candidate for a layout area nearest to the object area indicated by the object area information, as the layout area.

For example, where there are a plurality of information part illustrations 322, the information portion layout checking unit 143 selects, for each information part illustration 322, a candidate for a layout area that does not overlap another information part illustration 322, as the layout area.

After S143, the process proceeds to S144.

In S144, based on the layout area information and the object area information, the leader portion generation unit 144 generates the leader illustration 323 being an illustration that associates the information part illustration 322 with the object area.

Thus, the information illustration 320 including the information part illustration 322 and the leader illustration 323 is generated.

After S144, the process proceeds to S145.

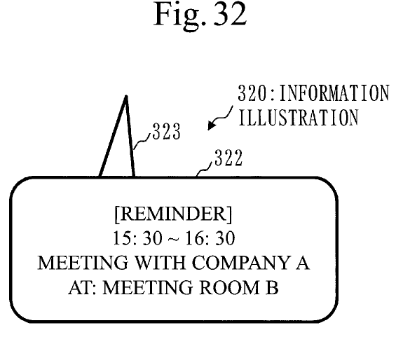

FIG. 32 is a diagram illustrating an example of the information illustration 320 according to Embodiment 7.

For example, the leader portion generation unit 144 generates the information illustration 320 as illustrated in FIG. 32 by generating the leader illustration 323.

The leader portion generation unit 144 may generate the leader illustration 323 integrally with the information part illustration 322 such that the information part illustration 322 and leader illustration 323 are seamless.

The shape of the leader illustration 323 is not limited to a triangle but may be an arrow or a simple line (straight line, curved line).

Where the distance between the object area and the layout area is less than the leader threshold, the leader portion generation unit 144 need not generate the leader illustration 323. Namely, where the layout area is near to the object area, the leader portion generation unit 144 need not generate the leader illustration 323. In this case, the information illustration 320 does not include a leader illustration 323.

Back to FIG. 29, the explanation resumes with S145.

In S145, the information illustration layout unit 145 generates an information image 329 in which the information illustration 320 is arranged in the layout area.

After S145, the process proceeds to S146.

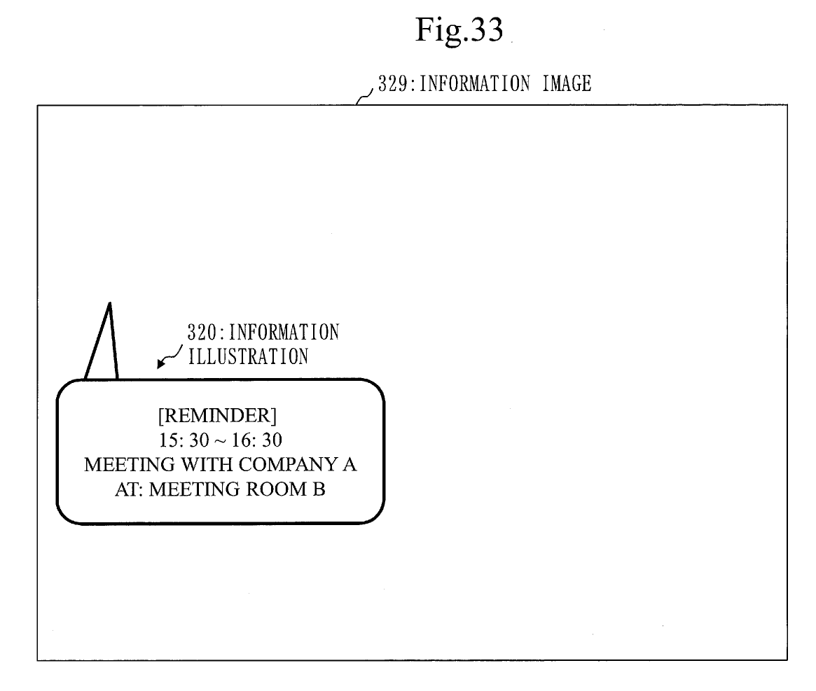

FIG. 33 is a diagram illustrating an example of the information image 329 according to Embodiment 7.

For example, the information illustration layout unit 145 generates an information image 329 in which the information illustration 320 is arranged as illustrated in FIG. 33.

Back to FIG. 29, the explanation resumes with S146.

In S146, the information image superimposing unit 146 generates the AR image 194 by superimposing the information image 329 over the photographic image 191.

For example, the information image superimposing unit 146 generates the AR image 194 (see FIG. 5) by superimposing the information image 329 (see FIG. 33) over the photographic image 191 (see FIG. 3).

After S146, the AR image generation process ends.

According to Embodiment 7, superimposing information can be superimposed and displayed over a photographic image to avoid an unusable area.

### Embodiment 8

An embodiment will be described in which a new display area 201 is selected from a photographic image 191 while excluding a detected display area 201.

Matters that are not described in Embodiments 1 to 7 will mainly be described hereinafter. Matters whose description is omitted are equivalent to those of Embodiments 1 to 2.

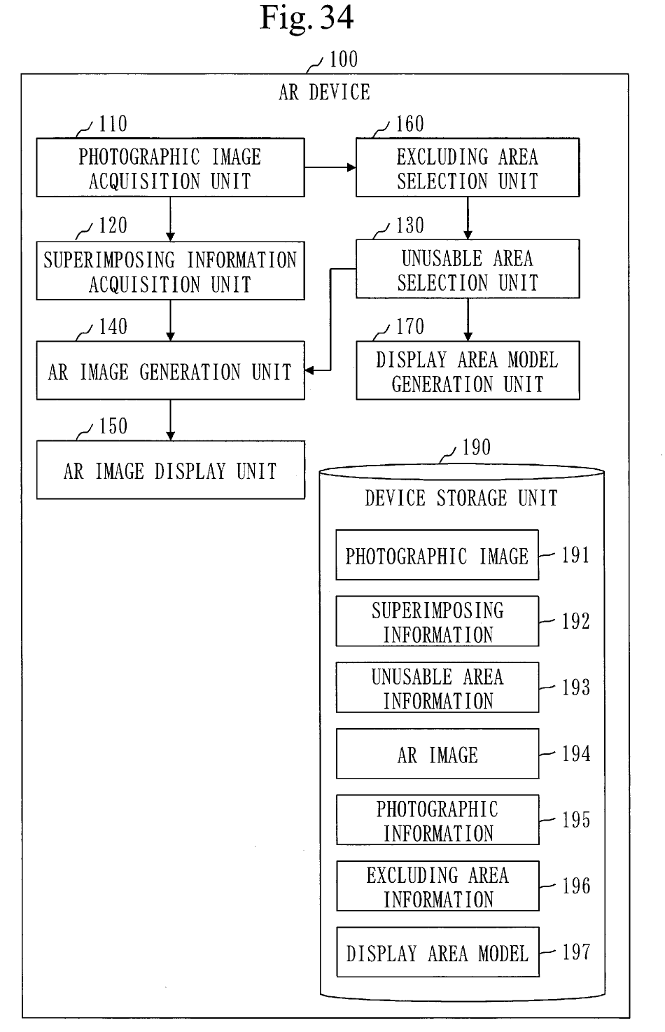

FIG. 34 is a functional configuration diagram of an AR device 100 according to Embodiment 8.

The functional configuration of the AR device 100 according to Embodiment 8 will be described with referring to FIG. 34. The functional configuration of the AR device 100 may be a configuration different from that in FIG. 34.

The AR device 100 is provided with an excluding area selection unit 160 and a display area model generation unit 170, in addition to the function described in Embodiment 1 (see FIG. 1).

Based on photographic information 195 and unusable area information 193, the display area model generation unit 170 generates a display area model 197 which expresses the display area 201 three-dimensionally. The display area model 197 is also called a three-dimensional model or three-dimensional planar model.

The photographic information 195 is information that includes the position information, orientation information, photographic range information, and so on of a camera of when the camera photographed the photographic image 191. The position information is information that indicates the position of the camera. The orientation information is information that indicates the orientation of the camera. The photographic range information is information that indicates a photographic range such as the angle of view or focal length. The photographic information 195 is acquired by a photographic image acquisition unit 110 together with the photographic image 191.

Based on the photographic information 195, the excluding area selection unit 160 selects the display area 201 indicated by the display area model 197 from a new photographic image 191. The selected display area 201 corresponds to an excluding area 398 to be excluded from the process of the unusable area selection unit 130.

The excluding area selection unit 160 generates excluding area information 196 indicating the excluding area 398.

An unusable area selection unit 130 excludes the excluding area 398 from the new photographic image 191 based on the excluding area information 196, selects a new unusable area 390 from the remaining image portion, and generates new unusable area information 193.

An AR image generation unit 140 generates an AR image 194 based on the excluding area information 196 and the new unusable area information 193.

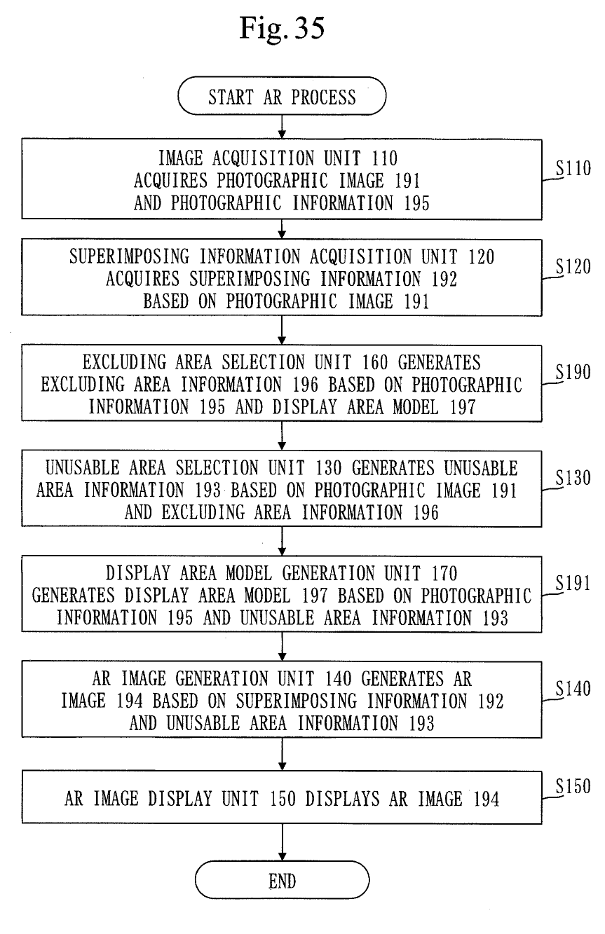

FIG. 35 is a flowchart illustrating the AR process of the AR device 100 according to Embodiment 8.

The AR process of the AR device 100 according to Embodiment 8 will be described with referring to FIG. 35. The AR process may be a process different from that in FIG. 35.

In S110, the photographic image acquisition unit 110 acquires the photographic image 191 in the same manner as in the other embodiments.

Note that the photographic image acquisition unit 110 acquires the photographic information 195 together with the photographic image 191.

For example, the photographic image acquisition unit 110 acquires the position information, orientation information, and photographic range information of a camera 808 of when the camera photographed the photographic image 191, from a GPS, a magnetic sensor, and the camera 808. The GPS and the magnetic sensor are examples of a sensor 810 provided to the AR device 100.

After S110, the process proceeds to S120.

In S120, the superimposing information acquisition unit 120 acquires the superimposing information 192 in the same manner as in the other embodiments.

After S120, the process proceeds to S191. S190 may be executed during a time period of between when S191 is executed and when S140 is executed.

In S190, the excluding area selection unit 160 generates the excluding area information 196 based on the photographic information 195 and the display area model 197.

After S190, the process proceeds to S130.

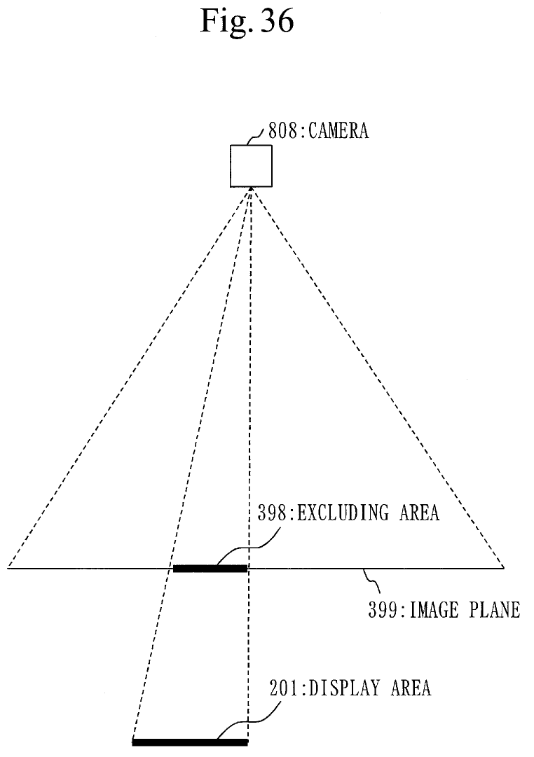

FIG. 36 is a diagram illustrating a positional relationship of the excluding area 398 according to Embodiment 8.

Referring to FIG. 36, the excluding area selection unit 160 generates an image plane 399 based on the position, orientation, and angle of view of the camera 808 indicated by the photographic information 195. The image plane 399 is a plane included in the photographic range of the camera 808. The photographic image 191 corresponds to the image plane 399 where the object is projected.

The excluding area selection unit 160 projects the display area 201 onto the image plane 399 based on the display area model 197.

Then, the excluding area selection unit 160 generates the excluding area information 196 which indicates, as an excluding area 398, the display area 201 projected onto the image plane 399.

Back to FIG. 35, the explanation resumes with S130.

In S130, the unusable area selection unit 130 generates the unusable area information 193 in the same manner as in the other embodiments.

Note that the unusable area selection unit 130 excludes the excluding area 398 from the photographic image 191 based on the excluding area information 196, selects the unusable area 390 from the remaining image portion, and generates the unusable area information 193 indicating the selected unusable area 390.

After S130, the process proceeds to S191.

In S191, based on the photographic information 195 and the unusable area information 193, the display area model generation unit 170 generates the display area model 197 which expresses three-dimensionally the display area 201 existing in the photographic range.

For example, the display area model generation unit 170 generates the display area model 197 in accordance with an SFM technique, using the current photographic information 195 and the last and preceding photographic information 195. SFM is a technique which, using a plurality of images, restores the three-dimensional shapes of the objects shown by the images and the positional relationships between the camera and the objects simultaneously. SFM is an abbreviation of Structure from Motion.

For example, the display area model generation unit 170 generates the display area model 197 using the technique disclosed in Non-Patent Literature 1.

After S191, the process proceeds to S140.

In S140, the AR image generation unit 140 generates the AR image 194 based on superimposing information 192 and the unusable area information 193, in the same manner as in the other embodiments.

After S140, the process proceeds to S150.

In S150, an AR image display unit 150 displays the AR image 194 in the same manner as in the other embodiments.

After S150, the AR process for one photographic image 191 ends.

According to Embodiment 8, a new display area 201 can be selected from the photographic image 191 to exclude the detected display area 201. Namely, the processing load can be reduced by treating the detected display area 201 as falling outside the processing target.

The individual embodiments are examples of the embodiment of the AR device 100.

Namely, the AR device 100 need not be provided with some of the constituent elements described in the individual embodiment. The AR device 100 may be provided with constituent elements that are not described in the individual embodiment. The AR device 100 may be a combination of some or all of the constituent elements of the individual embodiment.

The processing procedure described in the individual embodiment with using a flowchart and so on is an example of the processing procedure of a method and program according to the embodiment. The method and program according to the individual embodiment may be implemented by a processing procedure that is partly different from the processing procedure described in the embodiment.

In each embodiment, “unit” may be replaced with “process”, “stage”, “program”, and “device”. In each embodiment, the arrows in the drawing mainly express the flow of data or process.

### REFERENCE SIGNS LIST

100: AR device; 110: photographic image acquisition unit; 120: superimposing information acquisition unit; 121: object detection unit; 122: object identification unit; 123: superimposing information collection unit; 124: unusable area analyzing unit; 130: unusable area selection unit; 131: display area selection unit; 132: object area selection unit; 133: unusable area determination unit; 134: candidate area determination unit; 135: bezel portion detection unit; 136: candidate area editing unit; 138: unusable area information generation unit; 139: area condition information; 140: AR image generation unit; 141: information image generation unit; 142: information portion generation unit; 143: information portion layout checking unit; 144: leader portion generation unit; 145: information illustration layout unit; 146: information image superimposing unit; 150: AR image display unit; 160: excluding area selection unit; 170: display area model generation unit; 190: device storage unit; 191: photographic image; 192: superimposing information; 193: unusable area information; 194: AR image; 195: photographic information; 196: excluding area information; 197: display area model; 200: information processing device; 201: display area; 300: information processing image; 310: clock; 320: information illustration; 321: information illustration; 322: information part illustration; 323: leader illustration; 329: information image; 330: icon; 340: window; 341: window frame; 341U: frame upper portion; 341D: frame lower portion; 341L: frame left portion; 341R: frame right portion; 342: display part; 343: menu bar; 344: title; 345: button object; 390: unusable area; 391: object area; 392: candidate area; 393: bezel portion; 398: excluding area; 399: image plane; 801: bus; 802: memory; 803: storage; 804: communication interface; 805: CPU; 806: GPU; 807: display device; 808: camera; 809: user interface device; 810: sensor

1-23. (canceled)

24. An information superimposed image display device comprising:
an information superimposed image display unit to display an information superimposed image generated by superimposing superimposing information over a photographic image showing an information processing display device having an information processing display area as a display area, on a main body display area of a main body display device having the main body display area as a display area,
wherein the information superimposed image is an image in which the information is superimposed over an image area being selected from the photographic image to avoid a portion showing the information processing display area of the information processing display device,
the information superimposed image display device comprising:
a photographic image acquisition unit to acquire the photographic image;
a superimposing information acquisition unit to acquire the superimposing information;
an unusable area selection unit to select, as an unusable area, the portion showing the information processing display area, from the photographic image acquired by the photographic image acquisition unit; and
an information superimposed image generation unit to generate the information superimposed image, by superimposing the superimposing information acquired by the superimposing information acquisition unit over the photographic image to avoid the unusable area selected by the unusable area selection unit,
wherein the unusable area selection unit detects a window displayed in the information processing display area on behalf of an application program, from the photographic image, and selects the unusable area based on an image area that shows the detected window.

25. The information superimposed image display device according to claim 24,
wherein the window has a square window frame, and
wherein the unusable area selection unit detects a square frame in which a frame located on one side out of four sides is wider than frames located on the remaining three sides, as the window frame.

26. The information superimposed image display device according to claim 24, wherein the unusable area selection unit detects a plurality of windows, and selects the unusable area based on an image area that shows the detected plurality of windows.

27. The information superimposed image display device according to claim 24, wherein the unusable area selection unit detects a plurality of windows, merges two or more windows distant from each other by a distance smaller than a distance threshold into a window group, and selects the unusable area for each window group obtained by merging, based on an image area that shows the windows included in the window group.

28. The information superimposed image display device according to claim 24,
wherein the information processing display device has a device frame, and
wherein the unusable area selection unit detects a plurality of windows from the photographic image, detects an image area satisfying a condition for a frame shape formed of the device frame of the information processing display device, as a bezel area, merges two or more windows enclosed by the bezel region into a window group, and selects the unusable area for each window group obtained by merging, based on an image area that shows the windows included in the window group.

29. The information superimposed image display device according to claim 24,
wherein the information processing display device has a device frame, and
wherein the unusable area selection unit detects an image area satisfying a condition for a frame shape formed of the device frame of the information processing display device, as a bezel area, selects a bezel area enclosing the window, and selects an image area enclosed by the selected bezel area, as the the unusable area.

30. A non-transitory computer-readable recording medium which records an information superimposed image display program that causes a computer to execute:
an information superimposed image display process of displaying an information superimposed image generated by superimposing superimposing information over a photographic image showing an information processing display device having an information processing display area as a display area, on a main body display area of a main body display device having the main body display area as a display area;
a photographic image acquisition process of acquiring the photographic image;
a superimposing information acquisition process of acquiring the superimposing information;
an unusable area selection process of selecting, as an unusable area, a portion showing the information processing display area, from the photographic image acquired by the photographic image acquisition process; and
an information superimposed image generation process of generating the information superimposed image, by superimposing the superimposing information acquired by the superimposing information acquisition process over the photographic image to avoid the unusable area selected by the unusable area selection process,
wherein the information superimposed image is an image in which the information is superimposed over an image area being selected from the photographic image to avoid the portion showing the information processing display area of the information processing display device, and
wherein the unusable area selection process comprises a process of detecting a window displayed in the information processing display area on behalf of an application program, from the photographic image, and selecting the unusable area based on an image area that shows the detected window.

31. An information superimposed image display method comprising:
by an information superimposed image display unit, displaying an information superimposed image generated by superimposing superimposing information over a photographic image showing an information processing display device having an information processing display area as a display area, on a main body display area of a main body display device having the main body display area as a display area;
by a photographic image acquisition unit, acquiring the photographic image;
by a superimposing information acquisition unit, acquiring the superimposing information;
by an unusable area selection unit, selecting, as an unusable area, a portion showing the information processing display area, from the photographic image acquired by the photographic image acquisition unit; and
by an information superimposed image generation unit, generating the information superimposed image, by superimposing the superimposing information acquired by the superimposing information acquisition unit over the photographic image to avoid the unusable area selected by the unusable area selection unit,
wherein the information superimposed image is an image in which the information is superimposed over an image area being selected from the photographic image to avoid the portion showing the information processing display area of the information processing display device, and
wherein the unusable area selection unit detects a window displayed in the information processing display area on behalf of an application program, from the photographic image, and selects the unusable area based on an image area that shows the detected window.
